(19) United States
(12) Patent Application Publication
(10) Pub. No.: US 2015/0046676 A1
(43) Pub. Date: Feb. 12, 2015

(54) Method and Devices for Data Path and Compute Hardware Optimization

(71) Applicant: QUALCOMM Incorporated, San Diego, CA (US)

(72) Inventors: FITZGERALD JOHN ARCHIBALD, Toronto (CA); KHOSRO M. RABII, San Diego, CA (US)

(73) Assignee: QUALCOMM Incorporated, San Diego, CA (US)

(21) Appl. No.: 13/964,290

(22) Filed: Aug. 12, 2013

(51) Int. Cl. G06F 9/38

(52) U.S. Cl. CPC G06F 9/3885
USPC 712/28

(57) ABSTRACT

Methods and devices for distributing processing capacity in a multi-processor system include monitoring a data input for a feature activity with a first processor, such as a high efficiency processor. When feature activity is detected, a feature event may be predicted and processing capacity requirement may be estimated. The sufficiency of available processing capacity of the first processor to meet the estimated future processing capacity requirement and process the predicted feature event may be determined. Processing capacity of a second processor, such as a high performance processor, may be distributed along with the data input when the available processing capacity of the first processor are insufficient to meet the processing capacity requirement and process the predicted feature event.

### BACKGROUND

Modern system on chip (SoC) devices, such as those increasingly implemented in smartphones and other mobile computing devices, are becoming more integrated and powerful. As requirements for extending battery life in SoC devices while maintaining performance are becoming more stringent, providing solutions to performance, power and battery management issues while maintaining baseline functionality is becoming more and more challenging. The ability to distribute processing to various compute hardware resources enables the system to manage power usage and solve battery current limiting issues and other issues and to maintain functionality and responsiveness of the system while in a low power mode.

A typical SoC is configured with various computational hardware including digital signal processors (DSP), applications processors, graphics processing units (GPU) and other hardware devices, units or elements. Additionally, a SoC may have multiple instances of these hardware elements. However, the processing capabilities and the power efficiency of such hardware elements may vary, and thus the overall efficiency of the SoC may depend on which processors may be operating. To address this problem, various high processing power compute elements, which may also be elements that consume relatively larger amount of power, may enter a sleep mode when not in use. As an example, in a smartphone, a main processor may enter a sleep mode on a deterministic basis such as when no voice or data connections, or other known processing loads, are active. In the context of handling a voice or data session, for example, the main processor may wake according to a downlink schedule to check for activity according to known intervals, and process call related activities according to scheduling. For smartphones, or other systems that may be configured to process asynchronous events that may be external to the device or the network architecture, challenges exist in managing the entry of processors into low power mode, while maintaining “diligence” or the ability to recognize key events, such as a hand gesture, or activity in a camera scene or frame indicating the need for the main processor to awake.

Current solutions to managing the distribution of hardware resources rely on “call back” type interrupt-driven waking of processors to process events that have occurred or rely on wake-up schedules, static distributions or load balancing between processors based on relative computational demand. Such approaches involve significant latency or may be unable to process unforeseeable events, and thus may be unsuitable for unpredictable applications, such as computer vision applications. Further, interrupts associated with unscheduled events in current solutions may be relatively easy to generate based on the action or inaction of a hardware device, for example. Such actions may generate interrupts or other calls to wake up processing hardware to process events associated with activation or de-activation of the hardware device. Unforeseeable events in systems, such as computer visions systems, e.g. visual-feature events, or visual-feature activity, that may be embedded in a captured image, do not have significance relative to the operation of the hardware device and thus require a different approach.

### SUMMARY

Various aspects provide methods and devices directed to distributing processing in a multi-processor system (e.g. a system-on-chip (SoC)). Aspect methods may include processing a data input to detect a feature activity with a first processor, such as a high efficiency processor, digital signal processor (DSP), or other high efficiency processor. For example, the data input may be an image frames in a computer vision device/system, and the feature activity may be an object in the image frame. An aspect method may further include, estimating a future processing capacity in response to detecting the feature activity. Aspect methods may further include determining whether available processing capacity of the first processor is sufficient to meet the estimated future processing capacity requirement. An aspect method may further include signaling that processing the data input on a second processor, such as a high performance processor, applications processor or other high performance processor, will be required in response to determining that the available processing capacity of the first processor is insufficient to meet the estimated future processing capacity requirement. In an aspect, the multi-processor system may have N processing units the data input may be processed in one or more of the N processing units in response to determining that that the available processing capacities of the first processor and the second processor are insufficient to meet the estimated future processing capacity requirement. In an aspect, signaling that processing of the data input on a second processor will be required may include sending a message that the processing capacity of the second processor will be required in response to determining that the available processing capacity of the first processor are insufficient to meet the future processing capacity requirement and designating the processing capacity of the second processor to process the input data in response to receiving the message.

In further aspects, the data input may include data output from a hardware device under control of the first processor and control of the hardware device may be taken from the first processor by the second processor. The hardware device, in aspects, may include but is not limited to an image sensor, an infrared sensor, a light sensor, an ultrasound sensor, and an audio sensor. In further aspects, the multi-processor system may be a computer vision system. Accordingly, the data input may be an image frame or series of image frames (e.g., image frame data stream) and the feature activity may be visual-feature activity associated with the image frame. In a further aspect, the data input may be an image histogram associated with the image frame or may be a series of image histograms associated with the series of image frames and the feature activity may be visual-feature activity associated with the image histogram.

A further aspect method may include estimating a current processing capacity requirement based on the processing of data input by the second processor, determining whether an available capacity of the first processor is sufficient to meet the estimated current processing capacity requirement, and processing or transitioning processing of the data input on the first processor and transitioning the second processor to a low power state in response to determining that available processing capacity of the first processor is sufficient to meet the estimated current processing capacity requirement. An aspect method that includes processing to detect the feature activity may further include processing to detect an object in the image frame having a likelihood of being a start of a visual or movement gesture. An aspect method that includes estimating a future processing capacity requirement may further include estimating the future processing capacity requirement to recognize the visual or movement gesture within a series of image frames. A further aspect method that includes processing to detect the feature activity may further include processing to detect a face in the image frame and estimating a future processing capacity requirement may include estimating the future processing capacity requirement to perform facial recognition of a detected face within a series of image frames. In still other aspects, the data input may include audio data, processing the data to detect a feature activity may further include processing to detect a voice signal in the audio data, and estimating a future processing capacity requirement may include estimating the future processing capacity requirement to perform voice recognition on the audio data.

Further aspects include a multi-processor system (e.g., an SoC) having two or more processors configured with processor-executable instructions to perform operations of the methods described above. Further aspects also include a multi-processor system having means for performing functions of the methods described above. Further aspects include a non-transitory, processor-readable storage medium on which are stored processor-executable software instructions configured to cause one or more processors of a multi-processor system to perform operations of the methods described above.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1A is a block diagram illustrating a System-on-Chip (SoC) and exemplary feature monitoring in various aspects.

FIG. 1B is a system block diagram illustrating compute hardware, I/O hardware, and processes in various aspects.

FIG. 1C is a software architecture diagram illustrating a core configuration suitable for use with various aspects.

FIG. 1D is a software architecture diagram illustrating an alternative core configuration suitable for use with various aspects.

FIG. 2A is a diagram illustrating a feature detection in an aspect.

FIG. 2B is a diagram illustrating an alternative feature detection in an aspect.

FIG. 2C is a diagram illustrating an alternative feature detection in a further aspect.

FIG. 3A is a system activity diagram illustrating a feature activity event generation system in an aspect.

FIG. 3B is a system activity diagram illustrating an alternative feature activity event generation system in an aspect.

FIG. 3C is a system software architecture diagram illustrating an exemplary system configuration in an aspect.

FIG. 3D is a diagram illustrating feature event detection stages for forward processing capacity requirement estimation in various aspects.

FIG. 4A is a state diagram illustrating DSP, applications processor, and combined DSP/applications processor system and I/O hardware states in various aspects.

FIG. 4B is a state diagram illustrating alternative DSP, applications processor, and combined DSP/applications processor system and I/O hardware states various aspects.

FIG. 5A is a process flow diagram illustrating an aspect method of a feature activity event generation system.

FIG. 5B is a process flow diagram further illustrating an aspect method of a feature activity event generation system.

FIG. 5C is a process flow diagram illustrating an alternative aspect method of a feature activity event system.

FIG. 6 is a block diagram illustrating an exemplary mobile device suitable for implementation of various aspects.

FIG. 7 is a block diagram illustrating an exemplary mobile computing device suitable for implementation of various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The term “computing device” is used herein to refer to any one or all of cellular telephones, smartphones, personal or mobile multi-media players, personal data assistants (PDA's), laptop computers, desktop computers, tablet computers, smart books, palm-top computers, wireless electronic mail receivers, multimedia Internet enabled cellular telephones, televisions, smart TVs, smart TV set-top buddy boxes, integrated smart TVs, streaming media players, smart cable boxes, set-top boxes, digital video recorders (DVR), digital media players, and similar personal electronic devices which include a programmable processor, especially those that include an SoC.

The term “feature” as used herein may refer to a determinable or discernible characteristic of data. In various aspects, data may include image data and other data analyzed or to be analyzed by a processor. A feature may be determinable or discernible by a processor in the data presented to the processor, such as in an image frame, sound clip, or other block of data a sensor. The data may further be presented, e.g. from a sensor to a processor or other various computational units, in different forms, though from the same sensor. For example, the data may be presented from a sensor as an image histogram for activity detection in a high efficiency processor, such as a DSP. In such an aspect, image pixels may be discarded. During high performance processing, image data, such as pixel data associated with a full image, may be presented from the sensor to a high efficiency processor, such as an applications processor, ARM processor, multi-core processor, quad-core processor, or other high performance processor. In addition, the sensor may also present image histogram data to the high performance processor (e.g. different sensor data paths).

In aspects, no loss of data may occur; rather, the data may be presented in different forms and in quantity and quality on different data paths depending on the processor analyzing the data. Features may include certain determinable or discernible aspects of the frame or other block. Features may include but are not limited to value characteristics of the data (e.g. pixel values of an image frame), discernible objects within the data, content within certain regions or portions of the data, discernible objects within discernible regions, edges of objects within the data, movement associated with the edges of objects within the data, etc. In computer vision systems, features may include, but are not limited to, visual features. Visual features may include visual aspects of image data associated with a scene that is captured by a camera or other image sensing device, for example. Accordingly, the terms feature activity and feature events as used herein in connection with a computer vision system refer to visual-feature activity and visual-feature events occurring in an image scene that may be discerned by various processing activities that may be performed using the image data.

The various aspects address and overcome the drawbacks of current SoC power management methods and multi-processor system methods for switching tasks between processors. Aspects involve dynamically monitoring for the existence or absence of various feature activity or feature event precursors, such as precursors to gestures or visual-feature activity indicating that a gesture may be impending. Visual movement gestures or other gesture events recognized in camera images often require high-performance processing to reliably recognize, disambiguate and implement. To accommodate this when a lower-performance/higher-efficiency processor is monitoring visual images, the aspects enable the lower-performance processor to detect from input data when such higher-demand processes might be required, estimate the near future processing capacity requirements and take an action to activate, designate, reserve or otherwise set up for processing compute hardware and processing assets that may be required to process the input data and the feature activity or events before the activity or event begins (or at least at the start of the event). When no features are present in the data that require high-performance processing, processing may remain with or be transitioned to the low-performance, high efficiency processing assets so the high performance processing assets may remain or be placed in a low power state.

The various aspects estimate future processing capacity requirements for impending or predicted tasks, such as feature events, and transfer, distribute, or assign processing between one processor, such as a high performance, high-power consumption processor, to another processor, such as a high efficiency, low-power processor, such as from an applications processor to a DSP, from a DSP to an applications processor, or from a first processor to a second processor or additional processors. The estimation and transfer may be based on processing, detection and recognition of feature activity occurring in a processed frame, such as an image frame of a stream of data or data, such as histogram data or other transform or derivative data. The transfer or redistribution of processing may be based on progressively increasing or decreasing estimates of processing capacity requirements for a predicted feature event associated with the feature activity. Aspects involve dynamically monitoring for the existence or absence of various feature activity or feature event precursors that may be used to predict or anticipate impending processing demands, such as an image within a frame of a hand in a position that indicates that movement gestures may be about to begin. Movement gestures or other gesture events detected by a camera may involve complex image processing that requires a high-performance processor. So when such conditions are detected by a power-efficient processor, such as a DSP, an estimate or prediction of processing capacity requirements may be made and processing of images may be passed to a more capable applications processor when needed, while leaving the monitoring of images with the power-efficient processor when no features requiring significant processing are present. While implementation of the aspect methods among a DSP and an applications processor are disclosed herein as illustrative examples for ease of description, the invention is not limited to just those types of processors. For example, the high-efficiency processor may be a dedicated processor, such as a computer-vision hardware engine having a low gate count and low power processing unit or may be one of N processing units of varying capabilities.

In certain example systems, a high-efficiency processor may be assigned to process data from a sensor input module that is always on, such as a camera in a computer vision system or other sensors that may be associated with a natural user interface. Non-limiting examples of sensors include a camera, an electromagnetic sensor for detection of a specific wavelength or wide spectrum of wavelengths (e.g., light sensor, infrared sensor, UV light sensor, . . . ), sound or pressure sensors (e.g., audio, ultrasound, pressure, . . . ), and other sensors that gather data which occasionally requires significant processing. In a system aspect in which the sensor hardware is always on, the sensor hardware is always providing a data input to a processor, such as the high efficiency processor. The data input associated with significant events occurring in the environment monitored by the sensor may be difficult to distinguish from insignificant events at a basic hardware level. Processing of the input data is generally required to recognize and interpret features or events, recognize their significance, and determine whether the events require additional processing. For example, at a basic hardware level, a camera of a computer vision system is on and generating frames at all times regardless of the activity in the scene being monitored by the camera. Therefore, even when significant activity is present, there may be no changes in the basic hardware state that may be detected and used for generating event notifications.

To conserve power, basic monitoring of computer vision systems (e.g. processing image frames or image histogram data) may be processed by a low power, high efficiency processor. However, feature event processing may rapidly require high performance processing when activities or event precursors associated with impending feature events may be detected. Distributing or transitioning processing to a high efficiency processor when there is little processing to accomplish (e.g., monitoring image frames for a change or a particular shape) enables the system to conserve battery power by putting the high-performance processor into a low power state. By configuring the low power, high efficiency processor to anticipate when significant processing demands may be about to be imposed (e.g., recognizing an object in a scene that will require significant analysis), output from the high efficiency processor may be used to wake the high performance processor in time to take over such processing. Thus, feature events requiring more significant processing capacity may be processed in a relatively short amount of time. In some examples, a high efficiency processor may be handling incoming image frames, recognize that an event is impending, estimate that additional processing capacity will be required and transfer processing and hardware control to the high performance processor within a frame interval or shorter. The reduced latency has significant related advantages including reducing perceived response time, improving the reliability of feature or gesture sequence processing, reducing actual processing delay for processing events having operational significance, and reducing data loss, which also improves the processing integrity for operationally significant events.

In a heterogeneous processing system, advantages may be achieved by distributing processing capacity requirements between available processing capacity to attain a high level of processing efficiency when possible, and a high level of processing performance when necessary based on analyses performed by the high-efficiency processor (DSP). The detection of activity or data that will require significant processing may indicate that processing capacity of a high performance processor is required. Detection of little activity, such as after a period of time, may indicate that processing capacity of a high-efficiency processor is sufficient, and thus the high performance processor may be placed in a sleep mode.

Various aspects include an architecture that enables a low power mode where feature detection tasks may be distributed or otherwise offloaded, along with I/O hardware control, to a high-efficiency, lower power processor, such as a DSP. When certain feature activity is detected in I/O hardware data frames, an estimation of future higher processing capacity requirements may be made in connection with an impending feature event. Processing may be transitioned from or returned to a high performance processor for full feature event processing when it is determined that the processing capacity of the high-efficiency processor will not be sufficient to support the anticipated processing. When a new feature activity is detected, by processing input data, future processing capacity requirements may be estimated, for example by the high-efficiency processor, or in connection with a resource manager, or other main processor. Detection tasks may be selectively distributed between high-efficiency hardware elements, and high-performance elements depending on capacity availability and processing capacity requirements.

In aspects, a computer system, such as a system on chip (SoC) having multiple processors, such as N processing units of varying capabilities. Non-limiting examples of processors may include high efficiency processors, such as DSPs, modem processors, visual or graphics processing units (GPUs), dedicated high efficiency processing engines, dedicated high efficiency computer-vision hardware engines. Further non-limiting examples of processors may include high performance processors, such as applications processors, high performance processors with multiple processor cores, ARM architecture processors, or other processors that would be suitable in a multi-processor system. In aspects, a multi-processor system may be configured to distribute processing between processors of a variety of capabilities depending on feature activity and predicted feature events. Non-limiting examples of feature activity may include the presence of objects within an image frame, the presence of an audio signal in an audio frame, or other activity or precursor that may indicate that a feature event is impending. Examples of feature events may include, but are not limited to, facial recognition or other object recognition within an image frame, movement or gestures associated with an object within an image frame, or within a region of interest in an image frame, such as hand gestures, or other feature events including audio feature events as may be associated with speech or voice recognition.

Non-limiting examples of distributing processing include loading tasks or processes associated with processing predicted feature events into a task queue, task scheduler, or other supervisory system or operating system element. In aspects, distributing processing may involve signaling, messaging or other mechanisms to communicate that processing on one processor should be suspended or transferred to another processor along with transferring data input buffer addresses or other information regarding the input data. Resuming a suspended process may be conditional upon receiving a further indication, such as an inter-process communication message, an interrupt, or other indication that an event may be occurring and should be processed by the scheduled task. Processor resources, such as memory, data file resources, processing power resources, or other resources, may be distributed with the process or processes, task or tasks that may be associated with the estimated future processing capacity requirement.

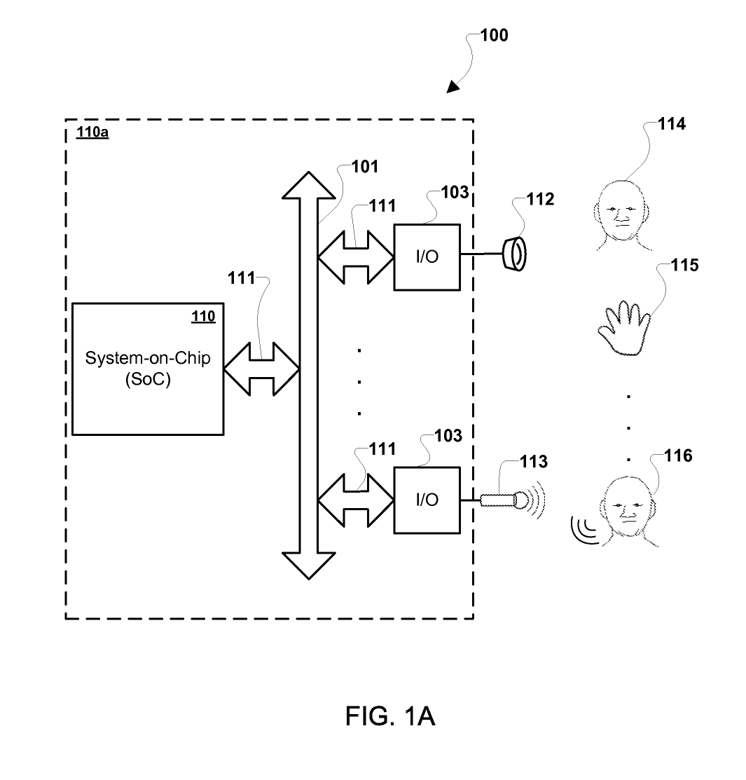

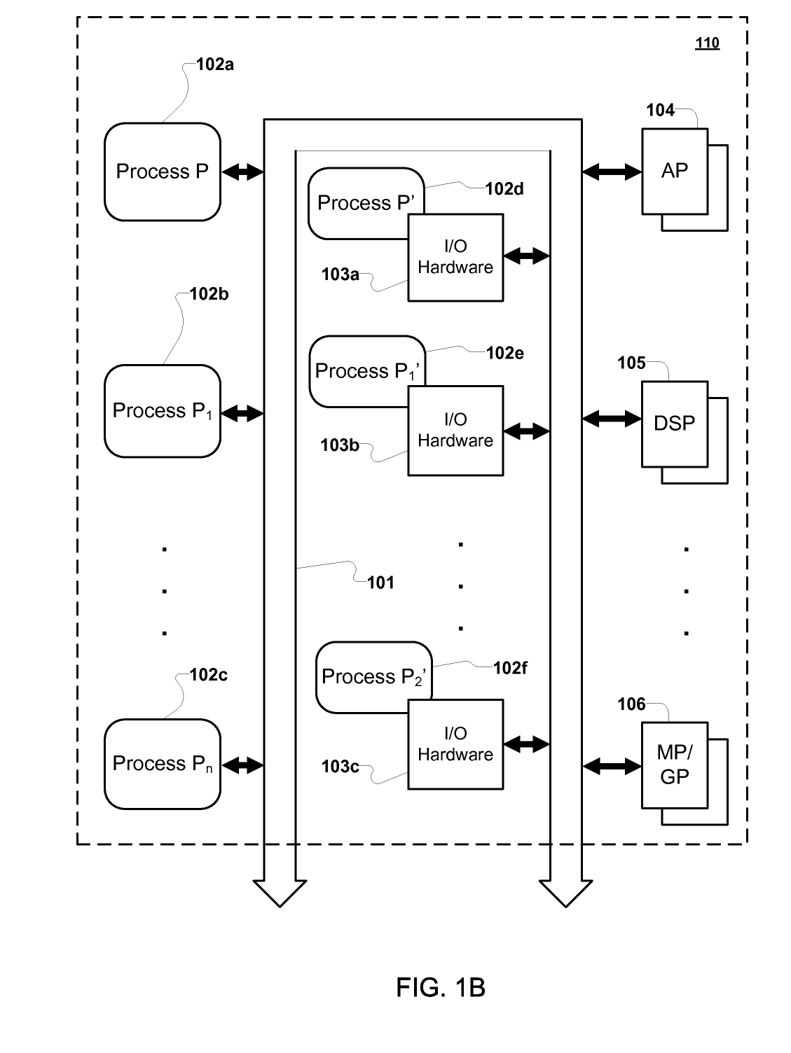

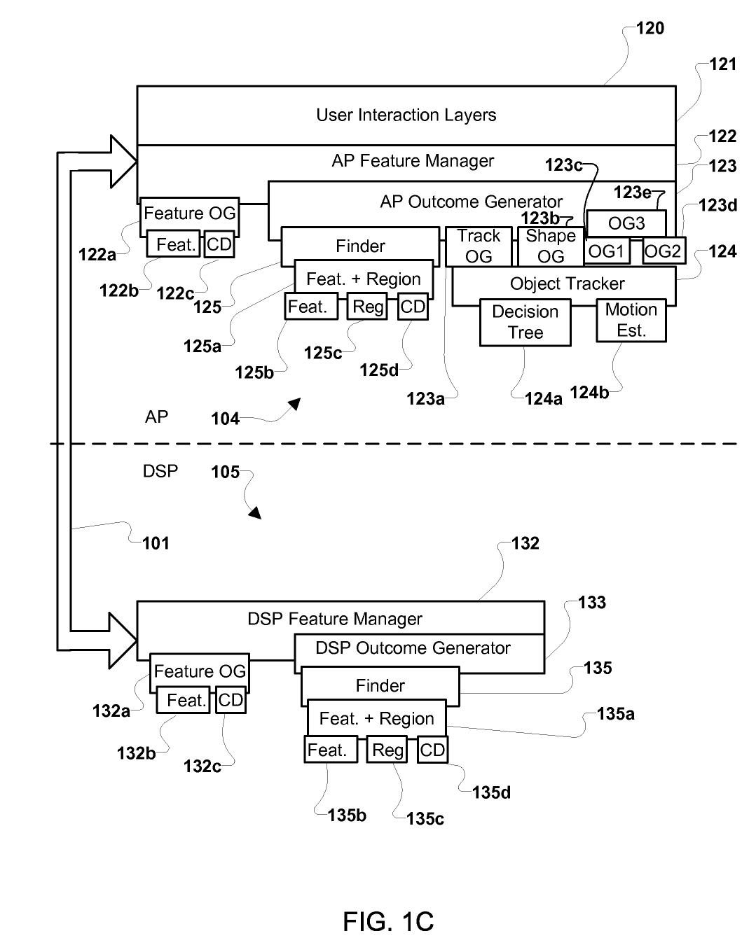

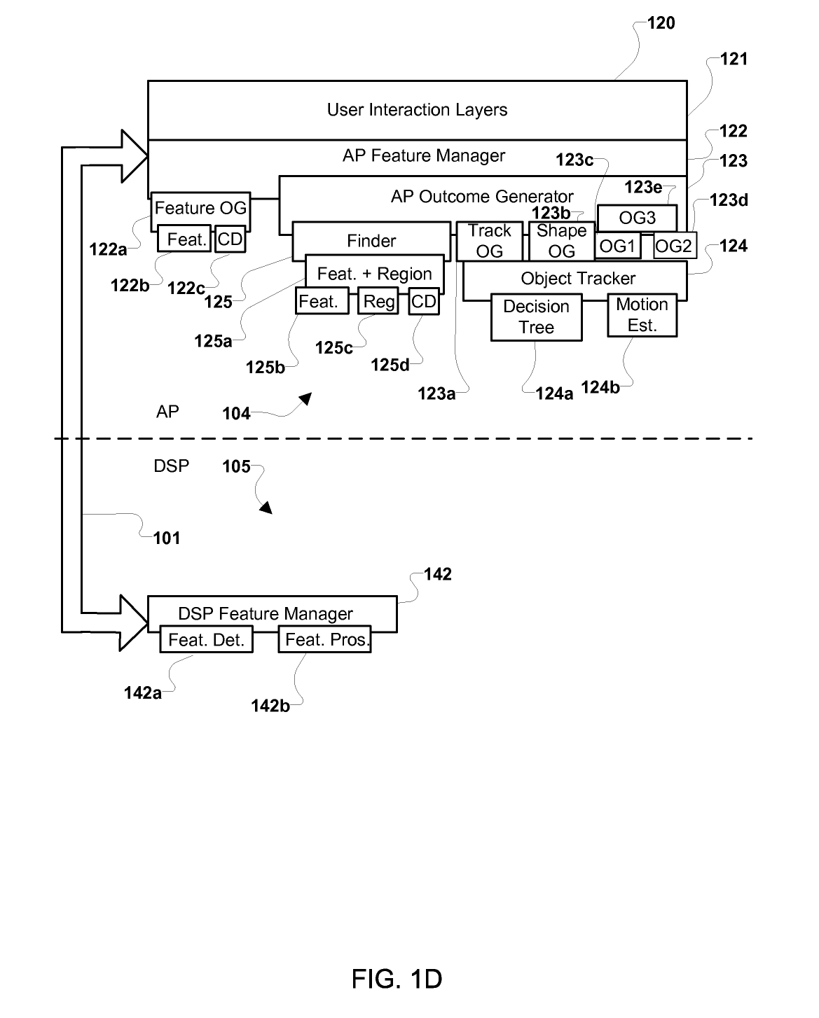

FIG. 1 illustrates a computer system 100, which may be configured as a multi-processor system for processing feature activity and feature events. The computer system 100 may includes a System-on-Chip (SoC) 110. Various I/O hardware modules 103 may be connected to sensor devices, such as a camera 112, a microphone 113, or other devices that may be coupled through connections 111 to the SoC 110 through a common data bus, such as a bus 101. The sensor device are not limited to the camera 112 or the microphone 113, but may include infrared sensors, light sensors for other wavelengths of light, sensors for electromagnetic energy, sound, vibration or pressure sensors, ultrasound sensors, or other sensors. In some examples, elements, such as the bus 101, and the I/O hardware modules 103, may be external to the SoC 110, or may be incorporated into a SoC 110a. In some examples, the I/O hardware modules 103 may be incorporated into the SoC 110. The I/O hardware modules 103 may be configured to process input from various I/O devices, such as a camera 112, and a microphone 113 and generate suitable output for further processing.

The data output from the I/O hardware modules or sensors is not limited. For example, in a computer vision system, the data output may be specific to the processor to which it is directed on a specific data path. In an aspect, the data output associated with the camera 112 may include image histogram data, image transform data, and other representative including the full image data and data other than the full image date. The camera 112 may be suitable for image capture and generation of image frames associated with a scene. The microphone 113 may be suitable for sound capture and generation of audio frames associated with detected audio. The scene may contain objects or features of interest, such as a face 114 for facial recognition or a hand with an open palm 115 for hand gesture recognition, or other image oriented features. The microphone 113 may be suitable for capture of sound features, such as a voice 116 for speech or voice recognition.

As described herein, features may include characteristics of objects that may be contained in a visual scene that has been captured within frames generated by the I/O hardware modules 103. The scene may contain objects or features of interest, such as a face 114 for facial recognition, a hand 115 for hand gesture recognition, or other image oriented features. Features are not limited to characteristics of the objects themselves, but may include actions of the objects, such as movement of the object. Features may further include recognition of the object, or position of the object within particular portions of the scene (e.g. region of interest), or may include particular frequencies of a sound feature. Features may also include more representative aspects, such as image histograms or other transforms. In additional to the full data collected by the sensor, such features may be output by the I/O hardware modules 103 as output data depending on the processor or processors and respective data paths to which the data is directed.

An exemplary architecture for a SoC-based feature activity and feature event processing system, is illustrated in FIG. 1B. The SoC 110 may include a wide variety and number of compute hardware elements, such as N processing units. Non-limiting examples of processors or processing units include an applications processor 104, which may include a multi-core processor, a digital signal processor (DSP) 105, a main processor (MP) or general-purpose processor (GP) 106. Additional compute hardware elements, processors or processing units may also include multiple versions of the applications processor 104, the DSP 105 and MP/GP 106 or other processing elements, such as Graphical Processing Units (GPUs), modem processors, computer-vision hardware engines with low gate counts and low power requirements, ARM processors, dual-core, quad-core, multi-core processors, RISC processors, CISC processor, controllers, or other processors of varying compute capabilities, efficiency, and power requirements.

The SoC 110 may further include other hardware elements, such as the I/O hardware modules 103a, 103b, and 103c, or the elements may be external to the SoC 110. Processes, such as software processes 102a, 102b and 102c may include application software, system software, device application software, or device driver software. The I/O hardware modules 103a, 103b, and 103c may be controlled with processes 102d, 102e and 102f, which may be application software, device-specific application software or device driver software or some combination thereof. The elements of the SOC 110, including the compute hardware elements the applications processor 104, the DSP 105 and the MP/GPU 106, the I/O hardware modules 103a, 103b, and 103c and the processes 102d, 102e and 102f may be coupled through the bus 101, which may represent one or more, or a combination of data lines, signal lines, control lines, power lines and other lines.

An example software architecture for a feature activity and features event processing system is illustrated in FIG. 1C. In the illustrated example, a low power mode may be activated and processing distributed from the applications processor 104 to a high-efficiency processor, such as the DSP 105. In an aspect, the software architecture may be configured such that based on estimates of processing capacity requirements associated with feature detection, all or a portion of processing may be offloaded to the DSP 105 from the applications processor 104. The applications processor 104 software architecture may include a user interaction layer or layers 121, which may represent high level software applications. The user interaction layer 121 may conduct higher level processing of feature events received from lower layers, and may provide feature results to a user interface, such as a display or other input or output technology. For example, in a gesture recognition system, the user interaction layer 121 may be a software application having certain processes that may be activated or advanced based on gesture input. In another example, the user interaction layer 121, in a facial recognition system, may provide an indication that the face has been recognized and display an identity and other information associated with the recognized face on a user interface. In still another example, the user interaction layer 121, in a voice recognition system may provide an indication that a voice has been recognized, and may associate the recognized voice with an image or other information associated with the recognized entity, which may be presented through a user interface on a display.

The software architecture may further include an applications processor feature manager 122 that may be responsible for higher level processing of feature activity generated from lower level modules or components. The applications processor feature manager 122 may receive feature related outcomes generated from the feature outcome generator 122a, which may receive low level feature inputs from the feature component 122b and change detector 122c. The applications processor feature manager 122 may also be logically coupled to an applications processor outcome generator 123 and may be responsible for providing low level feature input to the applications processor outcome generator 123.

In an aspect, more involved low level processing associated with features may be accomplished using an applications processor outcome generator 123, an object tracker 124 and a feature finder 125. The combination of modules may provide varying levels of processing from basic tracking, motion detection, estimation and outcome generation to higher level processing, such as recognition or event generation. A track outcome generator 123a may provide tracking outcomes to the applications processor feature manager 122, for example when objects have been identified for tracking. A shape outcome generator 123b may provide tracking outcomes to the applications processor feature manager 122, for example when shapes have been identified for tracking. Outcome generators OG1 123c, OG2 123d, and OG3 123e, exemplify that outcome generation may be layered and that specific outcomes from one module may be input to another module that may be configured to generate an outcome generation output.

Tracking of outcomes may be based on input generated from the object tracker 124 equipped, for example, with a decision tree module 124a and a motion estimation module 124b. The applications processor outcome generator 123 may further receive outcomes or basic input from the feature finder 125, which may be configured with a feature and region module 125a. Feature inputs may be generated from a feature module 125b that is configured to generate feature outputs. When combined with outcomes associated with a particular region as defined by region module 125c, and a change detection module 125d, the output of the feature module 125b may be used to narrow the area of interest in which the feature activities are to be detected, to a defined region, such as a region of interest (ROI). The enhanced feature processing represented by, for example, the applications processor feature manager 122, the applications processor outcome generator 123, the object tracker 124 and the feature finder 125 may require high-performance high power consumption processing as would be associated for example with the applications processor 104. However, when feature related activity is low, processing capacity requirements may be generally low. In such cases processing may be advantageously shifted to a higher efficiency processor, such as the DSP 105, and the applications processor 104 may enter a low power mode, such as a sleep mode or standby mode. In various aspects, switching between processors may be accompanied by a degree of delay or hysteresis. For example, hysteresis logic may be implemented based on time, activity level, detected events, or other criteria, to prevent conditions where excessive switching back-and-forth occurs between various computational units in a manner that would result in poor performance or inefficiency.

In the low power mode example, the DSP 105 software architecture may be configured to assume control over I/O hardware resources and conduct basic feature related processing by way of a DSP feature manager 132. In aspects, the DSP 105 may normally be assigned to process I/O data, such as image frame data, even when processing is being conducted elsewhere in the computer system 100. The DSP feature manager 132 may be configured with a feature outcome generator 132a, which receives feature related input from a feature module 132b and a change detection module 132c. The DSP feature manager 132 may be further configured to accept outcomes from the DSP outcome generator 133 which may be configured with a feature finder 135. Various outcomes may be generated through corresponding modules as the DSP 105 processes image frame data, including data that is representative of image frames, such as image histogram data, and determines that feature activity is taking place.

The decision regarding functions or outcomes associated with feature event or result generation may depend on the simplicity and efficiency of the processes being distributed. For example, basic feature detection within a particular region may involve simply identifying the presence of the feature within the region.

When an outcome associated with such feature detection is generated, such as by the feature outcome generator 130 2A, DSP outcome generator 133, or any of the modules coupled thereto, an estimate of future processing capacity requirements may be made. When the estimated future processing capacity requirements exceed the available processing capacity in the DSP 105, the applications processor 104 may be awakened from the low power mode in advance to conduct additional higher level processing that may be necessary for complete feature processing. Feature related events and results that may be subject to high-performance processing in the applications processor 104 may also be passed to the user interaction layers 120 as part of additional processing capacity requirements. Processing may be passed to the applications processor 104 through several mechanisms, such as through a message interface, an interrupt, a clock restart, or other mechanism. However, these mechanisms may be invoked based on estimates of future processing capacity requirements generated before higher performance processing is actually required. The applications processor 104 low power mode may alternatively be configured such that it may be partially active so as to be easily awakened through a handshake or other mechanism over the bus 101 when additional processing capacity is estimated to be required.

An example software architecture in a heterogeneous computer system, such as a SoC system, is illustrated in FIG. 1D. In the example heterogeneous computer system, which may be a feature activity event or result generation system, processing may be distributed between a high-performance processor and a high-efficiency processor. As in FIG. 1C, the software architecture for the applications processor 104 may include an applications processor feature manager 122 that provides low level feature related offense and results to user interaction layers 121. When processing demands for the applications processor 104 may be relatively low, or fall below a threshold, low level processing may be shifted to the DSP 105 in order to maintain an ability to detect feature activities while conserving battery power. A DSP feature manager 142 may receive input from a feature detection module 142a and a feature processing module 142b, which may be configured to detect basic features and conduct basic feature processing. The processing activities of the feature detection module 142a and the feature processing module 142b may be sufficient to generate results indicative of feature activities that are likely to be associated with impending feature events. The results may be used for estimating processing capacity requirements. The processing capacity requirement estimates may be used to request additional processing capacity from the applications processor 104 for conducting higher level processing.

For example, in an aspect, the example software architecture may be associated with a gesture recognition system. Feature events in a gesture recognition system may include a gesture made by a hand of a user in front of a camera associated with the system. The feature detection module 142a may detect feature activities, such as the presence of objects that meet the basic requirements for completing a gesture, such as the presence of an open palm in front of the system camera. The feature detection module 142a may conduct additional processing, such as the operation of an algorithm responsible for detecting any movement, or a particular kind of movement sufficient to indicate that a gesture event or other outcome should be generated by a higher-level module. The results from feature detection module 142a and feature processing module 142b may be input to a DSP feature manager 142 and an estimate made of processing capacity requirements for handling a completed gesture. Procedures associated with invoking additional processing capacity including waking up all or part of the applications processor 104 for high performance processing of the gesture events or results may begin.

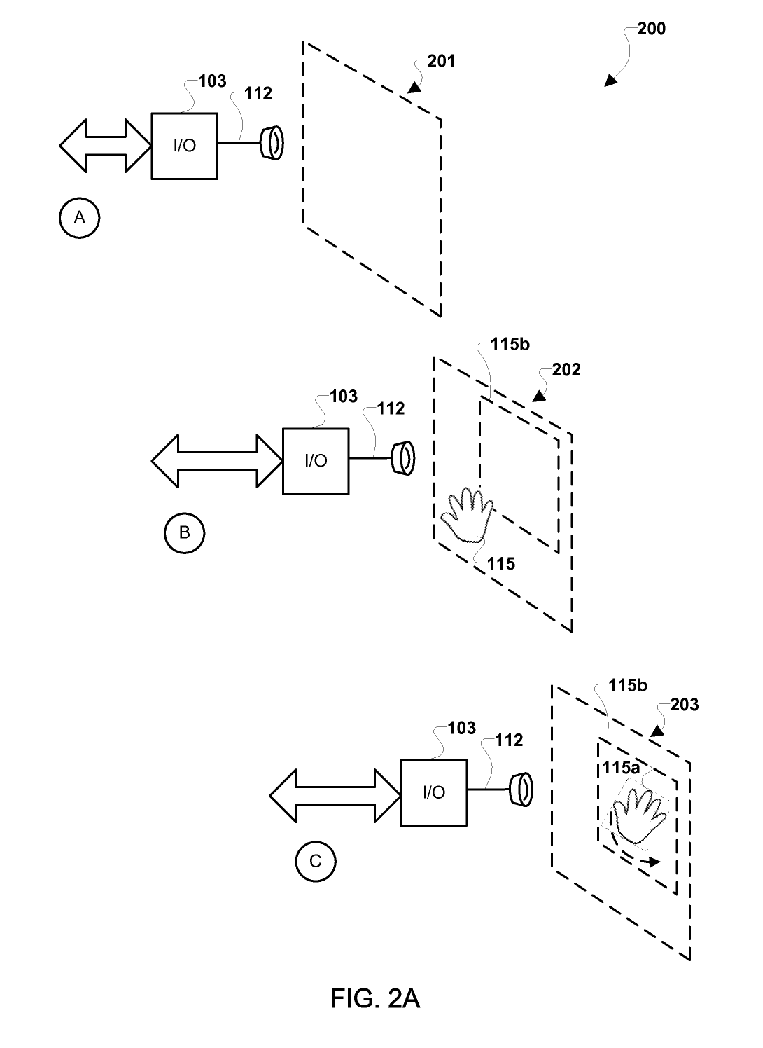

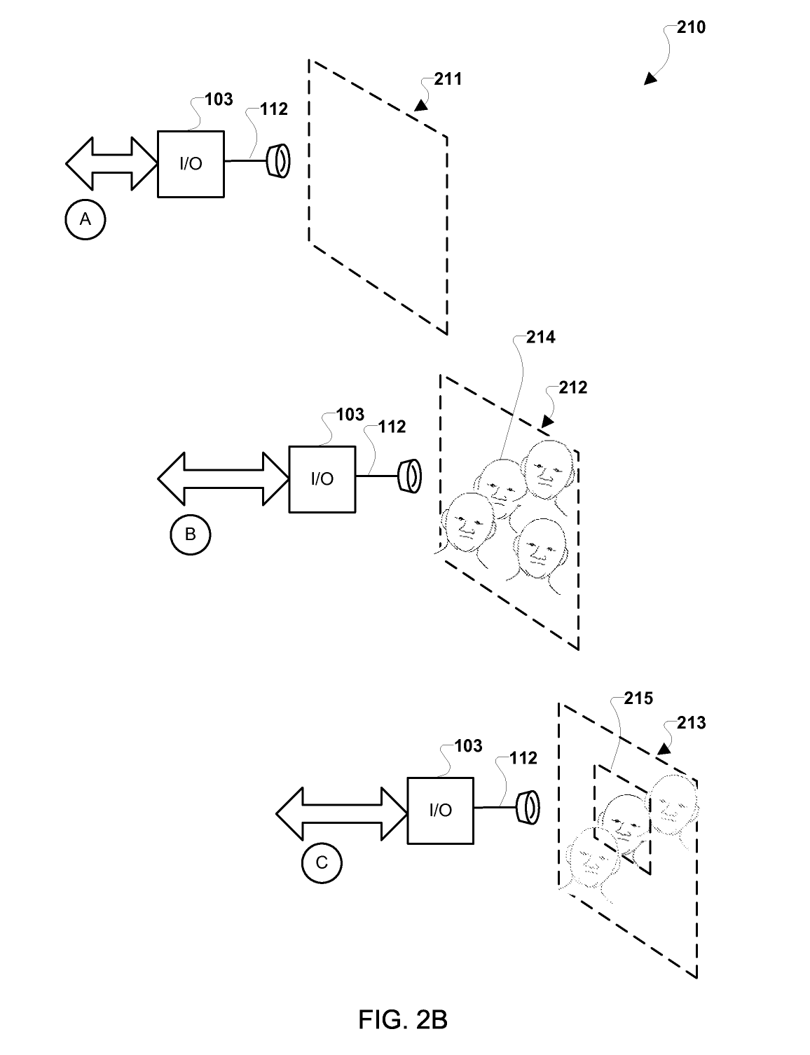

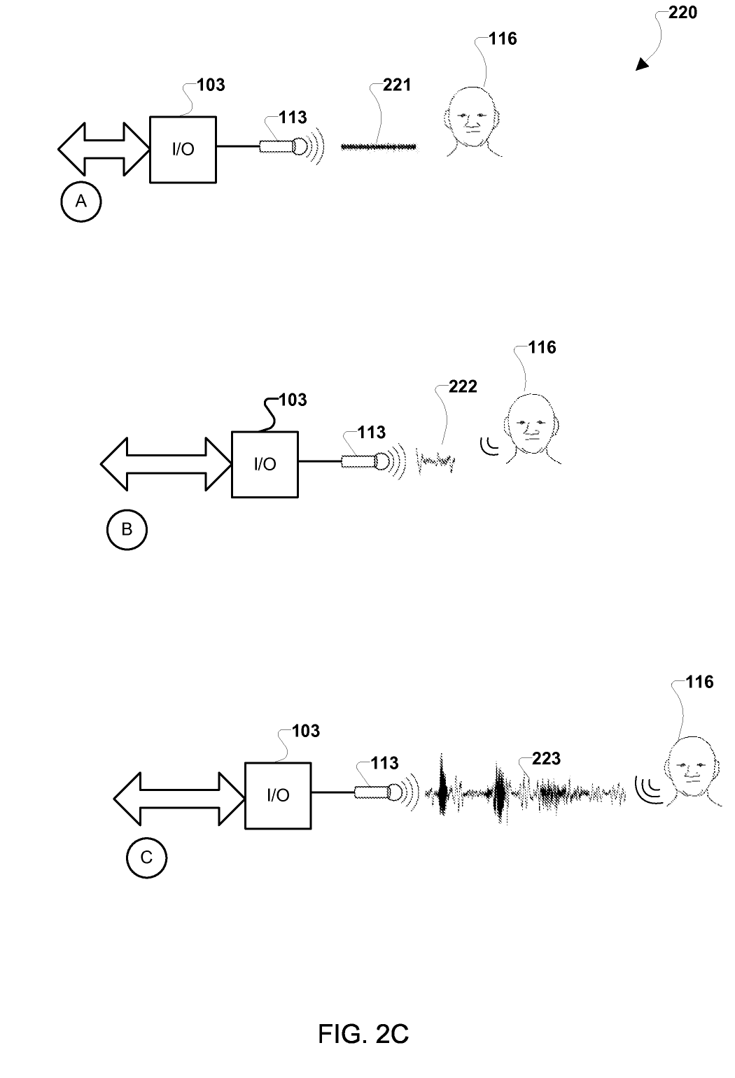

Examples of feature activity detection associated with various feature detection scenarios are shown in FIG. 2A, FIG. 2B and FIG. 2C. In FIG. 2A, which may be associated with a gesture recognition system example 200, a camera 112 may be coupled to an I/O hardware module 103. In the following description, the camera 112 and the I/O hardware module 103 may be continuously generating frames for output to various software subsystems. The following examples represent some of the different states of observation that may be possible within the camera scene and the image frames generated by the camera 112 and the I/O hardware module 103 including the presence and absence of feature activity.

The lack of feature activity may signal to the system, and the corresponding software architecture, that it may be possible for a high-performance processor associated with the gesture activity detection and gesture event and result generation system to enter a low power mode. For a heterogeneous system, the lack of feature activity may enable processing to be shifted from a high-performance processor to a high-efficiency processor. For example, when observing a blank scene or a scene that is not changing, the camera 112 may be generating one or more blank image frames 201, which may be designated as a first output A. The I/O hardware module 103 may generate the blank image frame 201 and subsequent frames, which reflect the absence of feature activity in the scene. In an aspect, the I/O hardware module 103 may, alternatively or in addition, output other than full image frame data. For example, the data output from the I/O hardware module 103 may be a transform of the image frame data, such as an image histogram or other transform. In further aspects, the data output from the I/O hardware module 103 may further be a reduced version of the image frame data, such as a compression or decimation of the image frame data.

For example, the camera system may observe a scene that includes the presence of an open palm 115, and the camera 112 may be generating one or more frames 202 that contain the open palm feature, which may be designated as a second output B. The I/O hardware module 103 may generate the frame 202 and subsequent frames, which indicate the presence of the open palm 115, but not within, for example, a region of interest 115b. The detection of the open palm 115, for example, by a module within the software architecture that is receiving the output B, may be sufficient to generate an estimate of a need for additional processing capacity from a high performance processor, such as the applications processor 104. Alternatively, if existing processing capacity is sufficient, additional processing, including further verification of an impending gesture may be conducted in the high efficiency processor, such as the DSP 105.

The camera system may observe a scene that includes the presence of the open palm 115a within the region of interest 115b, and possibly movement of the open palm 115a, representing a gesture. The camera 112 may be generating one or more frames 203 that contain the moving open palm feature, which may be designated as a third output C. The I/O hardware module 103 may generate the frame 203 and subsequent frames, which indicate the presence of the moving open palm 115a. The third output C, when processed, may result in an estimate that additional processing may be required.

FIG. 2B illustrates a facial recognition system example 210. When observing a blank scene, the camera 112 may be generating one or more blank image frames 211, which may be designated as a first output A. The I/O hardware module 103 may generate the blank image frame 211 and subsequent frames, which reflect the absence of feature activity and scene. In such a condition, when the first output A is processed, estimates associated with low processing capacity requirements may be generated. As with other examples, the lack of feature activity may signal to the system, and the corresponding software architecture, that it may be possible for high-performance processor, such as the applications processor 104, associated with the gesture activity detection and gesture event and result generation system to enter a low power mode. Alternatively, processing may be distributed between a high-performance and a high-efficiency processor in a heterogeneous system.

In the facial recognition system example 210, the camera 112 may observe a scene that includes the presence of various objects, such as faces 214 in a crowd. The camera 112 may be generating one or more frames 212 that contain the faces 214, which may be designated as a second output B. The I/O hardware module 103 may generate the frame 212 and subsequent frames, which, in an aspect, may be placed in a frame buffer. When the frame 212, frames, or the frame buffer is read by a feature activity related module, the presence of the faces 214 may be detected and an estimate of the required processing may be generated. The estimated required level of processing may be compared to a threshold value to determine whether more processing capacity may be required than available with the current processor (e.g., a DSP). In the present example, the feature event or result may be the recognition of a particular face 215 within the faces 214. The camera 112 may be generating one or more frames 213 that contain the particular face 215 within the faces 214 designated as a third output C. The I/O hardware module 103 may generate the frames 213 and subsequent frames, which indicate the presence of the particular face 215. When the third output C is processed, an estimate may be generated that additional processing capacity may be required.

FIG. 2C illustrates a voice recognition system example 220. When recording or otherwise observing a quiet audio scenario, which may be indicated by a lack of voice frequency energy from voice 116, or by a noise level, which is below a certain threshold, the microphone 113 may be generating empty or silent audio frames, an audio stream, or otherwise filling an audio buffer or file with empty audio content 221, which may be designated as a first output A. The I/O hardware module 103 associated with microphone 113 may generate an output associated with the empty audio content 221 and subsequent content, which reflect the absence of feature activity, such as a recognized voice. In such a condition, estimates associated with low processing capacity requirements may be generated. As with other examples, the lack of feature activity may signal to the system, and the corresponding software architecture, that it may be possible for high-performance processor associated with the voice recognition activity detection and feature event and result generation system to enter a low power mode, or to distribute processing between a high-performance and a high-efficiency processor in a heterogeneous system.

In the voice recognition system example 220, the microphone 113 may begin to pick up signal energy that includes the presence of voice frequency energy, such as signal energy content 222 signifying the possibility of an utterance. The microphone 113 may be generating audio data, such as generating audio frames, an audio stream, or otherwise filling an audio buffer or file with signal energy content 221, which may be designated as a second output B. The I/O hardware module 103 may generate the signal energy content 221 and subsequent data, such as an audio stream or a buffer containing the audio data, which, when read by a feature activity related module, may indicate the presence of the signal energy content 221. An estimate may be generated that indicates that additional processing capacity may be required.

In the voice recognition system example 220, the feature event or result may be the recognition of a particular utterance 223, such as a particular word, or the recognition of a particular voice signature identifying a speaker. Thus, the voice recognition system may pick up voice energy associated with the particular utterance 223, which may be designated as a third output C. The microphone 113 may be generating audio data, such as generating audio frames, an audio stream, or otherwise filling an audio buffer or file with the particular utterance 223, and the I/O hardware module 103 may generate an output including the audio data associated with the particular utterance 223. When the audio output is read by a feature activity related module, the presence of the particular utterance 223 may be recognized and an estimate generated that additional processing capacity may be required.

In the above described examples, the outputs A, B and C from the I/O hardware module 103 represent various degrees of feature activity related detection, which when processed by modules in the system software architecture, may result in an estimate being generated indicating that additional processing capacity will be required. When the estimate is processed, for example by a resource manager, the processors or processing units, or other module associated with distributing processing, the processing of the feature event may be transitioned between various processors depending on available capacity and modes of operation. For example, as a result of the generation of output A, which may be representative of a lack of feature related activity, the estimated processing capacity requirement may be relatively low. Thus, a high-performance processor may enter a low power mode where no high level feature event processing may be necessary. As a result of the generation of output B, which may result in an estimate indicating that feature activity will be impending, high-performance processing may be required. Thus, all or a portion of the high-performance processor may exit the low-power mode and take over processing associated with the feature activity. As a result of the generation of output C, which may represent the actual features that require high-performance processing, processing capacity requirement estimates may be relatively high. Such estimates may indicate the need for additional processing capacity. Additional processing capacity may be distributed to accomplish the additional processing. In the event previous estimates were made and additional processing previously distributed, the high-performance processor may already be in a condition to perform full processing of the feature activity.

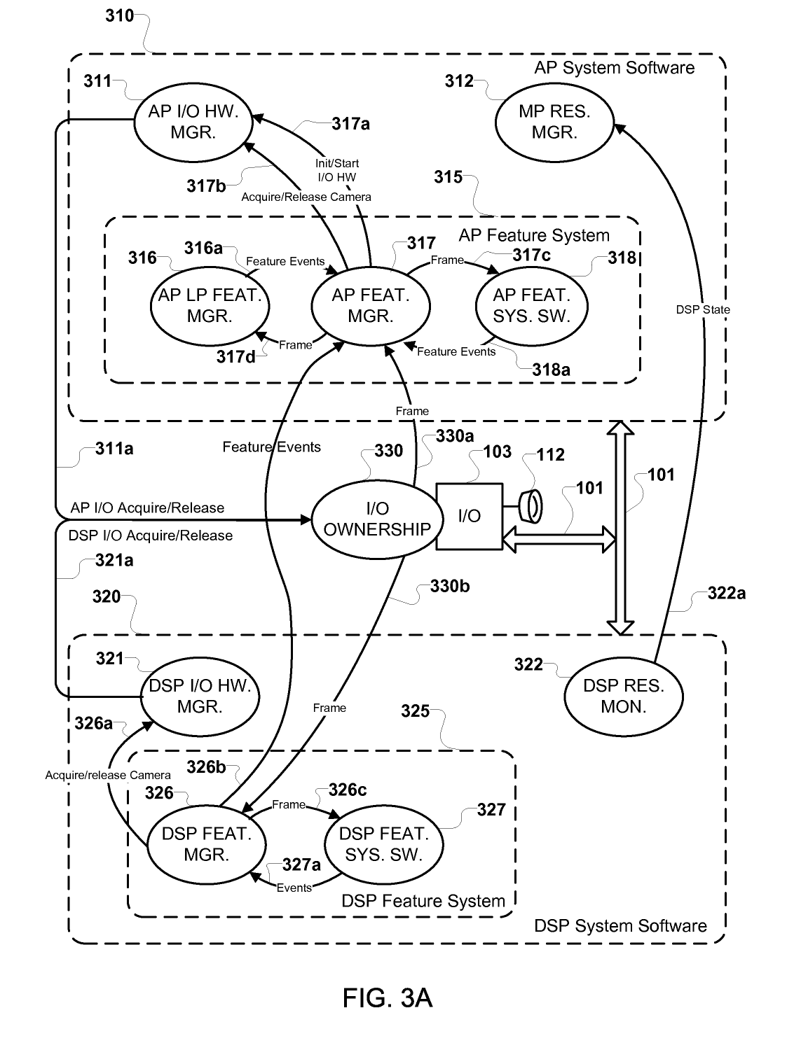

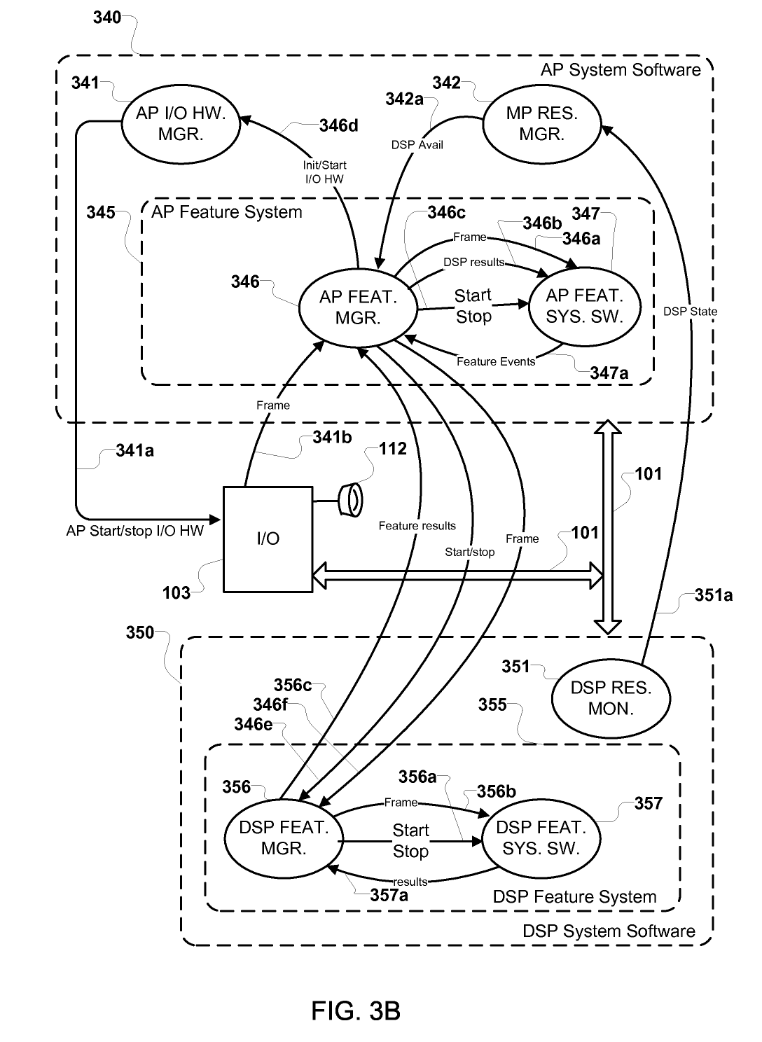

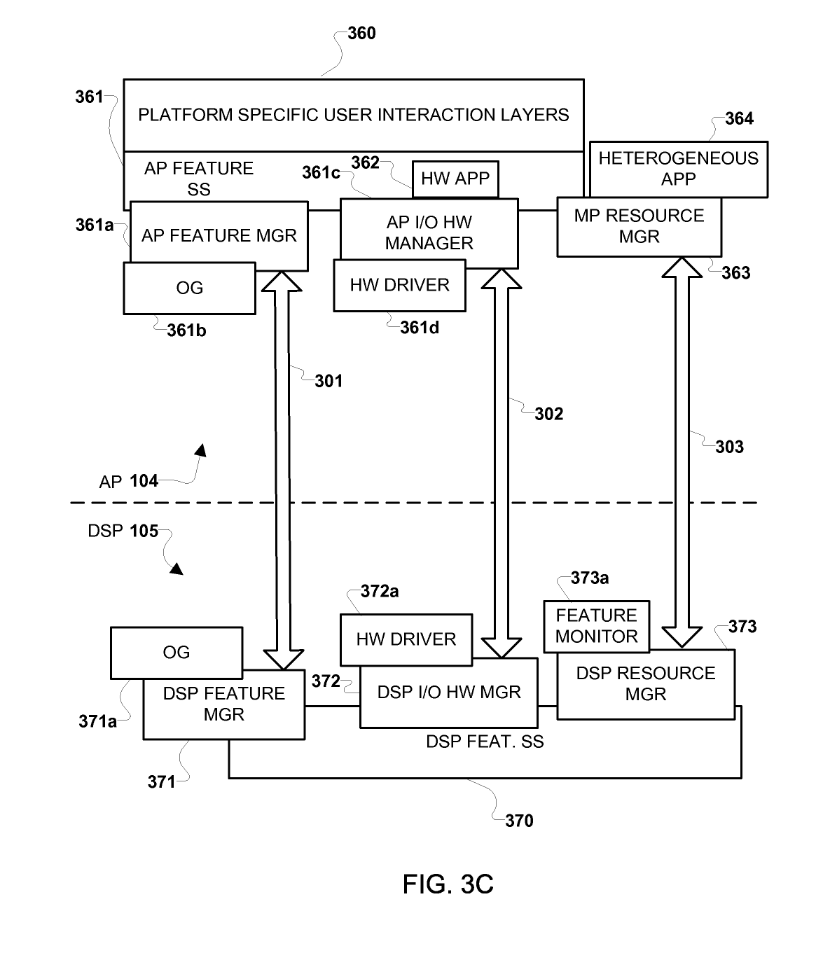

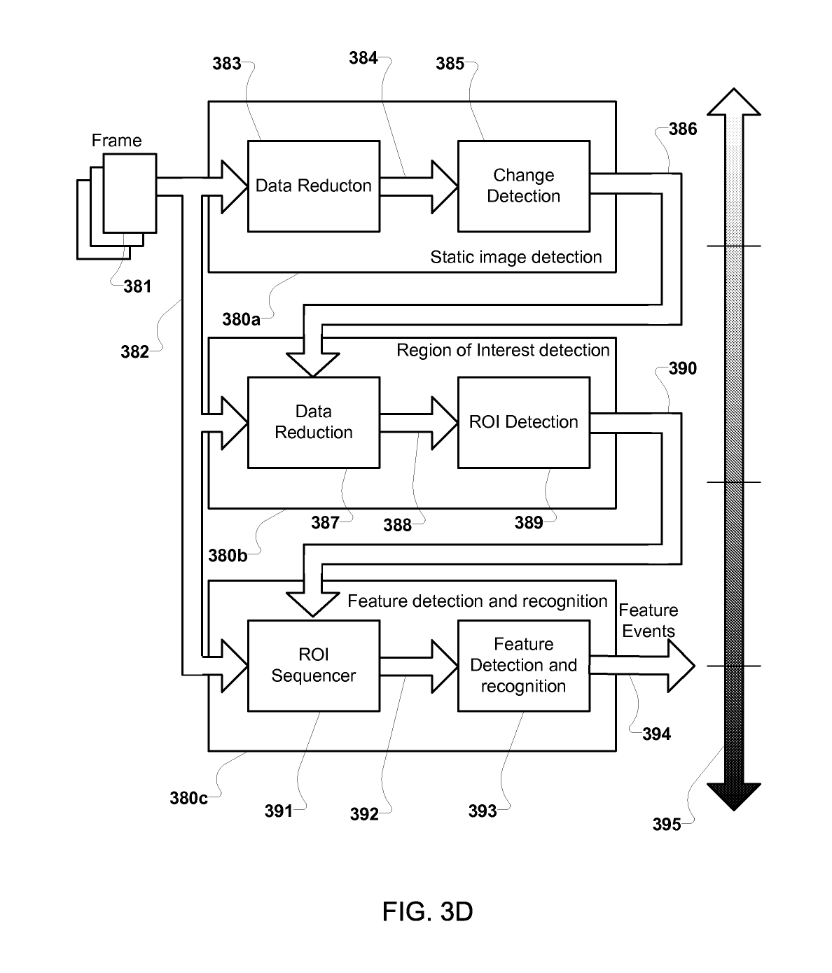

Processing for feature activity detection and feature results and events generation in an example system may allow processing capacity estimates to be made and allow processing to be transitioned or distributed between high-performance and high-efficiency processors in advance of the events requiring additional processing. Continuity of task handing may thereby be maintained for important operations, such as feature event processing. Challenges arise however in maintaining processing continuity, such as maintaining management over hardware and system resources while processing transitions may be taking place. FIG. 3A is system activity diagram that shows examples of various activities that may take place during operation of a feature activity event generation system in which estimates may be made and a high-performance processor may enter a low power mode. Processing may be transitioned to a high-efficiency processor. Operation of the system may be conducted in system software modules associated with both the high-performance processor and the high efficiency processor, such as the applications processor 104 and the DSP 105, through an applications processor system software 310, which may include an applications processor feature system 315 and a DSP system software 320, which may include a DSP feature system 325.

During operations in which the high efficiency processor, such as the applications processor 104, is handling feature activity event processing, the applications processor feature system 315 may have ownership of I/O resources through control of an I/O ownership module 330 of the I/O hardware, such as a camera 112 and the I/O hardware module 103. The I/O hardware may be started or initialized from an applications processor feature manager 317 through a start signal 317a issued to an applications processor I/O hardware manager 311. The applications processor feature manager 317 may acquire ownership of the camera by sending an acquire/release camera signal 317b to the applications processor I/O hardware manager 311, which may secure control of the hardware by sending an applications processor I/O acquire/release signal 311a to the I/O ownership module 330. A frame 330a may be generated by the camera 112 and the I/O hardware module 103 and received by the I/O ownership module 330 and forwarded to the applications processor feature manager 317. The frame may be forwarded as frame 317c to an applications processor feature system software 318, which may be responsible for handling feature activity processing as described herein. The feature activity processing may include low level processing of features, such as change detection, feature detection, motion detection, or other low level processes, which may require high efficiency processing capacity. Feature event processing may include high level processing, which may require high-performance processing capacity. Feature event processing may include feature recognition and passing feature events and results to user interaction layers.

A main processor (MP) resource manager 312 may be responsible for monitoring a state of the DSP 105 by receiving a DSP state signal 322a from a DSP resource manager 322. When no feature activity is detected, or when activity falls below a threshold, an estimate may be generated indicating that high performance processing capacity is not required. The applications processor 104 may prepare to offload processing and to enter a sleep mode by sending the acquire/release camera signal 317b to the applications processor I/O hardware manager 311 to release the hardware. The applications processor I/O hardware manager 311 may issue the applications processor I/O acquire/release signal 311a to the I/O ownership module 330 to release ownership of the camera 112 and the I/O hardware module 103. When processing is transitioned to the DSP system software 320, the DSP feature system 325 may prepare for assuming responsibility for processing of feature events. A DSP feature manager 326 may send an acquire/release camera signal 326a to a DSP I/O hardware manager 321. The DSP system software 320 may acquire ownership of the camera 112 and the I/O hardware module 103 by sending a DSP I/O acquire/release signal 321a from the DSP I/O hardware manager 321 to the I/O ownership module 330. The transition between the applications processor system software 310 to the DSP system software 320 may further be controlled through interaction over the bus 101 and may include the transference of I/O frame buffers and other process related information.

When processing is being conducted by the DSP system software 320, such as when the applications processor 104 is in a low power mode, the I/O ownership module may forward frame 330b to the DSP feature manager 326. The frame 330b may be forwarded as frame 326c to a DSP feature system software 327 such that processing, for example, to generate feature events, may be conducted. Feature events 327a may be forwarded to the DSP feature manager 326. The feature events 327a may be representative of low level feature detection from the DSP feature system software 327. The DSP feature manager 326 may forward feature events 326b to the applications processor feature manager 317. The feature events 326b may include frame information such that the applications processor feature manager 317 may forward the frame 317d to an applications processor low power feature manager 316, which may confirm that the feature events 326b are significant. The DSP feature system software 327 may forward the events 327a for interpretation or alternatively, the DSP feature system software 327 may itself, in some aspects, identify that significant feature events have occurred, in which case the DSP feature manager 326 may forward the feature events without interpretation.

The applications processor low power feature manager 316 may send the feature events 316a, which may be confirmed feature events, to the applications processor feature manager 317 to estimate a processing capacity requirement and determine that processing may be returned to the applications processor 104. The DSP I/O hardware manager 321 may release the camera 112 and the I/O hardware module 103 by sending the DSP I/O acquire/release signal 321a to the I/O ownership module 330 and ownership returned to the applications processor system software 310.

FIG. 3B is system activity diagram that shows various activities that may take place during operation of an example feature activity event generation system in which processing in a heterogeneous system is dynamically distributed between a high-performance processor and a high-efficiency processor. Operation of the system may be conducted in system software modules associated with both the high-performance processor and the high efficiency processor, such as the applications processor 104 and the DSP 105, through an applications processor system software 340. The applications processor system software 340 may include an applications processor feature system 345 and a DSP system software 350 including a DSP feature system 355. As previously noted, while the 104 and the DSP 105 are used as examples of high performance and high efficiency processors for ease of description, any number of different types of processing units may be implemented in various aspects, such as N processing units with varying capabilities. In the case of N processing units, processing capacity requirements may be distributed dynamically among various processing capacity of various ones, combinations of ones, or all of the N processing units.

In the example illustrated in FIG. 3B, during operation in which the high efficiency processor, such as the applications processor 104, is handling feature activity and feature event processing and when dynamically distributing processing between high performance and high efficiency processors, the applications processor feature system 345 may maintain ownership of the I/O resources, such as the camera 112 and the I/O hardware module 103. The hardware may be started or initialized from an applications processor feature manager 346 through an initialize/start signal 346d issued to an applications processor I/O hardware manager 341. The applications processor I/O hardware manager 341 may control the I/O hardware by sending an applications processor start/stop I/O hardware signal 341a to the I/O hardware module 103. A frame 341b may be generated by the camera 112 and the I/O hardware module 103 and forwarded to the applications processor feature manager 346. The frame may be forwarded as frame 346a to an applications processor feature system software 347, which may be responsible for handling feature activity and feature event processing as described herein.

The feature activity processing may include low level processing of features, such as change detection, feature detection, motion detection, or other low level processes. The feature event processing may include high-performance processing, such as feature recognition and handling forwarding feature events and results to user interaction layers. In aspects, forwarding of a frame as described herein may include forwarding complete sensor data, such as a frame containing complete image data. Alternatively or in addition, the frame may include data generated by a sensor, such as image histogram data, image transform data, or other data depending on the processing unit to which the data is directed. It may also be possible in aspects that full data is sent to one processing unit along one data path and partial data is sent to another processing unit along another data path. Partial data may refer to sensor data that is representative of a characteristic of the full sensor data (e.g., a histogram), or may be representative of sensor data associated with a region or portion of the full sensor data (e.g., ROI).

A main processor (MP) resource manager 342 may be responsible for monitoring the state of the DSP 105 by receiving a DSP state signal 351a from a DSP resource monitor 351. In various aspects, the DSP resource monitor 351 may be configured to estimate the availability and efficiency of various programmable and non-programmable computing hardware units and data paths. The DSP resource monitor 351 may be equipped with, use or have access to hardware resources such as timers, current meters, status registers, operating system states and statuses, and other resources. The DSP resource monitor 351 may further be implemented as a software module that executes in one of the computing devices and monitors other programmable and non-programmable devices. Alternatively, the DSP resource monitor 351 may be implemented as a software module that may be distributed among the computing devices. In other aspects, the DSP resource monitor 351 may be a computer, controller, logic, or other hard-wired device that can be coupled to devices to be monitored by hard wire connections and include hard-wired logic. Alternatively, the DSP resource monitor 351 may be a software module that executes on a programmable device and may monitor resources associated with programmable and non-programmable devices. While the DSP resource monitor 351 is described above, the above description may be further applicable to other resources monitors. The output from the resource monitor may be used in connection with resource managers as described herein to distribute processing among computing elements.

The availability of the DSP 105 for processing may be indicated by the MP resource manager 342 to the applications processor feature manager 346 by a DSP availability signal 342a. Depending on an estimate of processing capacity requirements, the availability of the DSP 105, when the level of feature activity detected is relatively low, or when activity falls below a threshold, or when it is determined that it would be efficient to transfer processing to the DSP 105, the applications processor 104 may prepare to transition some amount of processing to the DSP 105. The applications processor feature manager 346 may send a DSP result 346b to the applications processor feature system software 347 for processing along with frame 346a depending on the amount of processing distributed to the DSP 105. The applications processor feature system software 347 may generate and send feature events 347a to the applications processor feature manager 346, which may take over the higher level processing of the feature events including passing the feature events to user interaction layers and receiving user generated input.

In aspects, transitioning a portion of the processing to the DSP system software 350 involves stopping the applications processor feature system software 347 by sending a start/stop signal 346c from the applications processor feature manager 346, sending a start/stop signal 346e to start a DSP feature manager 356 and forwarding frame 346f to the DSP feature manager 356. A DSP feature system software 357 may be started by sending a start/stop signal 356a from the DSP feature manager 356, and the frame 346f may be forwarded as a frame 356b to the DSP feature system software 357. The frame 356b may be processed by the DSP feature system software 357 to generate feature results 357a, which may be sent to the DSP feature manager 356. The feature results 357a may be forwarded to the applications processor feature manager 346 as feature results 356c. The dynamic distribution of processing between the applications processor system software 340 and the DSP system software 350 may further be controlled through interaction over the bus 101.

The above examples of system activity may be further understood with reference to an example software architecture as illustrated in FIG. 3C. As with previous examples, the distribution between a high performance processor and a high efficiency processor may be described with reference to the applications processor 104 and the DSP 105 as illustrative and non-limiting examples. Forward or future processing capacity requirements may be estimated from processing frame data, which in the present example, may include image or vision data frame. The processing may include monitoring and basic feature activity detection, such as object presence activity detection, gesture activity detection, or other feature activity detection that may be used to predict and estimate processing capacity requirements. The portion of the software architecture associated with the applications processor 104 may include one or more platform specific user interaction layers 360, an applications processor feature system software 361, a hardware application 362, a main processor resource manager 363 and, for an aspect involving a heterogeneous architecture, a heterogeneous application 364.

The portion of the software architecture associated with the DSP 105 may include a DSP feature software system 370, a DSP feature manager 371, and the DSP resource manager 373 and associated sub-modules. For example, the DSP feature manager 371 may include an outcome generator 371a, which is responsible from generating feature related outcomes, such as feature detection, recognition, change detection, and other feature related outcomes. The DSP I/O hardware manager 372 may include a hardware driver 372a, which may be responsible for providing access to basic hardware features, such as hardware control features. The DSP resource manager 373 may include a feature monitor 373a, which may be responsible for monitoring various feature related activity to determine whether the activity is significant for the purpose of estimating and invoking an amount of feature processing in the applications processor 104.

The example software architecture may be broadly described as including system components, such as a feature manager, a hardware manager, and a resource manager that may be divided between the applications processor 104 and the DSP 105. To facilitate communication between the divided manager components, communication channels may be established between the architecture components. The communication channels may include a feature manager link 301, a hardware manager link 302 and a resource manager link 303. The communication channels may include communication mechanisms, such as interprocess communication mechanisms used to control forward distribution of processing between the applications processor 104 and the DSP 105 and also to share information, such as frame information or feature information depending on the state of operation.

The forward estimation of processing capacity requirements in accordance with aspects, is further illustrated in FIG. 3D. Processing may be conducted at several levels including static image detection in a processing block 380a for basic image detection. For example, a frame of the image stream may be input to a data reduction block 383, which may perform a histogram function, transform function, a compression function, a decimation function, or other function to reduce the data to be further processed. Data reduction may also be used to highlight data of interest for detection, such as edges or other significant aspects of the image without sending full image data, although full image data may be available to be sent along some data paths. A reduced representation 384 of the image frame 381, or successive frames in a stream of frames, such as may be generated by a video camera or other image capture device, may be input to a change detection block 385. When the content of the reduced representation 384 of the frame 381 is representative of or otherwise indicates that a static image is present, then an estimate may be made that no significant processing is required. Processing for change or activity detection may involve constant run-time execution with relatively low computational demand, such as in the order of around several microseconds.

When the reduced representation 384 of the frame 381 contains some change, the change detection block 385 may output the detected change 386 to a region of interest detection block 380b for determining whether the change has occurred in a designated region of interest indicating the change is associated with a feature of significance. The detected change 386 and the frame 381 may be input to an optional data reduction block 387. An optionally reduced representation 388 of the frame 381 and the detected change 386 may be input to a region of interest detection block 389. When the content of the optionally reduced representation 388 is representative of or otherwise indicates that the detected change has not occurred within the region of interest, then an estimate may be made that additional processing capacity is not required. Processing for region of interest detection may involve constant run-time or periodic run time execution with computational demand being significantly higher than for change or activity detection, such as in the order of around several hundreds of microseconds. In some examples, processing capacity within the DSP 105 may be sufficient to address the change processing, however the feature activity may indicate that feature events may be impending that may require processing capacity beyond that which may be available within the DSP 105.

When the content of the optionally reduced representation 388 is representative of or otherwise indicates that the detected change has occurred within the region of interest, the region of interest detection block 389 may output the detected feature 390 to a feature detection and recognition block 380c for generating a feature event that will likely require additional amounts of processing. An estimate for additional processing capacity requirements may be generated. The detected feature 390 and the frame 381 may be input to a region of interest sequencer 391 and a region of interest frame 392 may be input to a feature detection and recognition block 393. Processing for feature detection may involve variable run-time with computational demand being, for example, in the order of up to around 30 ms depending on the region of interest and feature mode. An estimation of the processing capacity requirements may be developed based on the progression of the detection activities for the feature along a continuum 395, which indicates that, as the activity progresses from an inactive scene with no changes, to a detected change, to a detected change within the region of interest, to a detected and recognized feature, and so on, more processing capacity will be required.

A resource manager may monitor the current processor capacity among all the system processors, and other system resources, and may make determinations based on the capacities and availability of processor and processing capacity among the various processors. For example, if the processing capacity estimates indicate that expected processing demands correspond to processing capacity available within the high efficiency processor, the processing may remain in the high efficiency processor. When expected processing demands will exceed the processing capacity of the high efficiency processor, then processing capacity from the high performance processor or other processor or processors may be invoked. In aspects, blocks of processing capacity of a particular size may be distributed such that the entire processing capacity of the high performance processor need not be invoked. Similarly, when detected feature activity results in an estimate that less capacity will be required, processing capacity of the high performance processor may be released in blocks. Further, the processing capacity requirements may be estimated and a distribution of processing capacity may be made based on a constant block size, a variable block-size, or based on other distribution mechanisms.

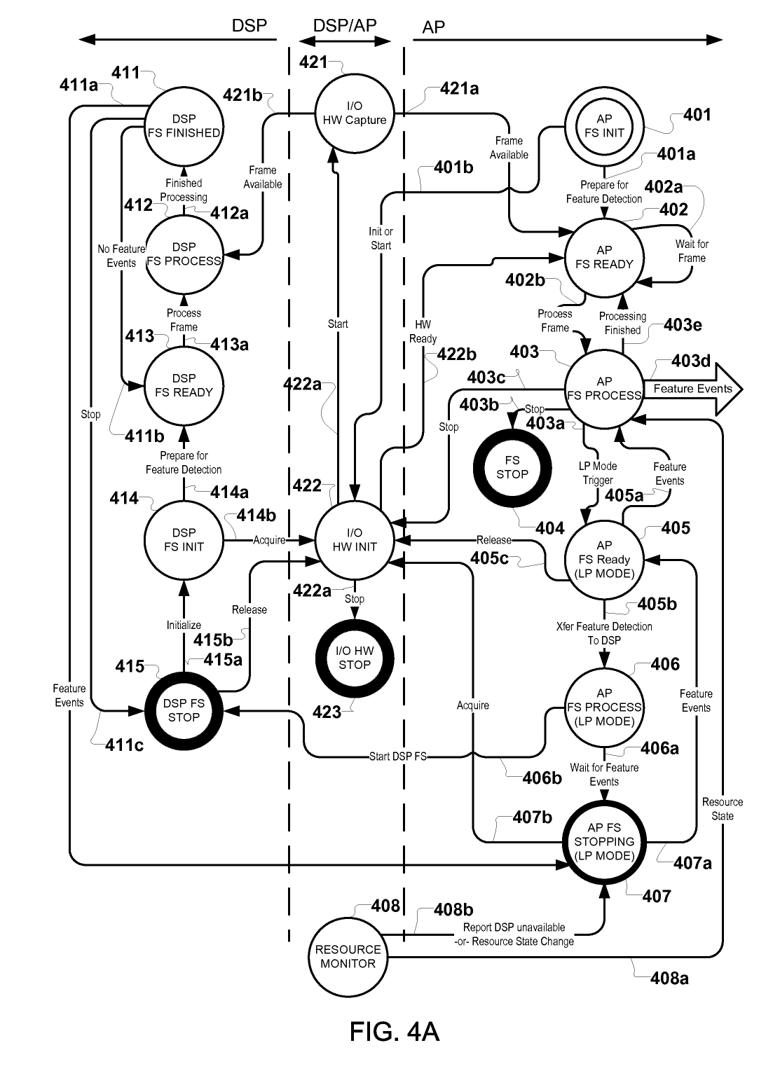

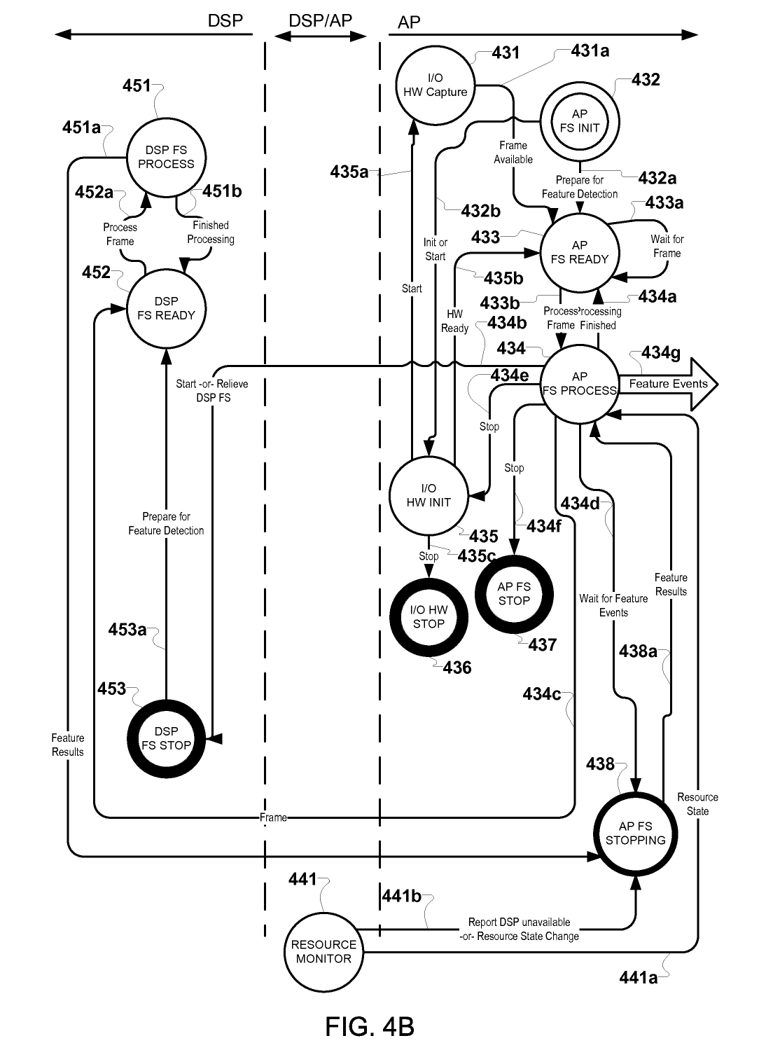

Aspects may be further understood with reference to a detailed state diagram as shown in FIG. 4A, which illustrates various states associated with a low power configuration. The high-performance processor, such as the applications processor 104, may enter a low power mode and processing may be conducted in a high efficiency processor, such as the DSP 105. In FIG. 4A and FIG. 4B, states may be represented by circles. Feature activity, feature events, conditions, signals or other actions, may be referred to in connection with the following state diagram descriptions collectively as events. In the state diagram description, events that may cause state transitions may be represented by lines between states having arrows indicating the direction of state transition caused by the event, e.g. from one state to another state, or in some instances to the same state. The events causing the transitions may be signals, messages, data, or other actions that result in a state transition.

Assuming an initial condition whereby feature event processing is being performed in the high performance processor, an example feature system may be started or initialized in an applications processor feature system initialization state 401. The system may prepare for feature activity detection and may be placed into an applications processor feature system ready state 402 by an event 401a, such as a signal or message indicating that initialization is complete. The hardware may be initialized or started from the applications processor feature system initialization state 401 and placed into an I/O hardware initialization state 422 by an event 401b. The I/O hardware may be started or otherwise brought into a condition to begin processing and may be placed into an I/O hardware capture state 421 by an event 422a. The I/O hardware may be in a condition to begin processing input, and may indicate readiness to the applications processor feature system ready state 402, by an event 422b, that the I/O hardware is in an operational state and ready to begin providing frame data. The I/O hardware capture state 421 may indicate to the applications processor feature system ready state 402, by an event 421a, that frames are available for processing. The applications processor feature system ready state 402 may loop, by an event 402a, while waiting for a frame. When the event 421a is received, the applications processor feature system ready state 402 may indicate to an applications processor feature system processing state 403, by an event 402b, to begin processing a frame. The applications processor feature system processing state 403 may generate feature events 403d, which may be processed or may be passed for processing to higher layers, such as user interaction layers as previously described. When the feature events 403d have been generated, the applications processor feature system processing state 403 may indicate to the applications processor feature system ready state 402, by an event 403e, that processing is finished, at least until addition processing is required for subsequent feature activity and feature events.

As previously described when feature activity ceases, or falls below a threshold for a period of time, which may be from several milliseconds to several seconds and possibly longer or shorter depending on the application, processing capacity requirement estimation may be conducted and a processing transition may begin. The applications processor 104 may begin a process to be placed in a low power mode and to transition processing to the DSP 105. The applications processor feature system processing state 403 may indicate to an applications processor low power (LP) mode feature system ready state 405, by an event 403a, indicating that a lack of activity, sufficient to trigger the LP mode, has occurred. The applications processor LP mode feature system ready state 405 may indicate to the I/O hardware initialization state 422, by an event 405c, that the I/O hardware is being released, and may further indicate to an applications processor LP mode feature system processing state 406 that feature detection is being transferred to the DSP 105 by an event 405b. The applications processor LP mode feature system processing state 406 may indicate to an applications processor LP mode feature system stopping state 407, by an event 406a, to wait for feature events. The applications processor LP mode feature system stopping state 407 may indicate to a DSP feature system stop state 415 associated with DSP 105 to start the DSP feature system by an event 406b.

As the DSP feature system begins to become operative, the DSP feature system stop state 415 may indicate to a DSP feature system initialization state 414, by an event 415a, to initialize. The DSP feature system initialization state 414 may indicate to a DSP feature system ready state 413 to prepare for feature detection, by an event 414a, and may further indicate to the I/O hardware initialization state 422 that the DSP 105 is acquiring control over the I/O hardware by an event 414b. The DSP feature system ready state 413 may indicate to a DSP feature system processing state 412 to process a frame by an event 413a. The I/O hardware capture state 421 may indicate to the DSP feature system processing state 412 that a frame is available for processing, by an event 421b, and the frame may be accordingly processed. When the frame is finished processing, the DSP feature system processing state 412 may indicate to a DSP feature system finished state 411 that processing is finished by an event 412a. The DSP feature system finished state 411 may indicate or otherwise pass feature events over to the applications processor 104 and, in particular, to the applications processor LP mode feature system stopping state 407 by an event 411a. When no feature events are detected, the DSP feature system finished state 411 may indicate to the DSP feature system ready state 413, by an event 411b, that no feature events are detected.

A resource monitor state 408 may report the resource state, including respective processing capacities, to the applications processor feature system processing state 403 and may further report a resource state change and/or the availability state of processing capacity of the DSP 105 to the applications processor LP mode feature system stopping state 407. The applications processor LP mode feature system stopping state 407 may forward the feature events to the applications processor LP mode feature system ready state 405 by an event 407a. The applications processor LP mode feature system ready state 405 may forward the feature of events to the applications processor feature system processing state 403, by an event 405a, for example to determine the significance of the feature events. Based on the feature events indicated by the event 411a, the resource state indicated by the event 408a and the resource state change and/or the DSP availability indicated by the event 408b, and based on feature events forwarded to the applications processor feature system processing state 403, by events 407a and 405a, an estimate of processing capacity may be made and the applications processor 104 may resume feature processing. Feature processing may be resumed when the applications processor LP mode feature system stopping state 407 indicates to the I/O hardware initialization state 422 that the I/O hardware is being acquired, by an event 407b. The applications processor—side processing may begin or resume in the applications processor feature system initialization state 401. The DSP feature system finished state 411 may indicate to the DSP feature system stop state 415 that the DSP feature system may stop, by an event 411c, and the DSP feature system stop state 415 may indicate to the I/O hardware initialization state 422 to release the I/O hardware by an event 415b. In the event that feature processing is stopped, the applications processor feature system processing state 403 may indicate a stop condition to a feature system stop state 404, by an event 403b. The applications processor feature system processing state 403 may further indicate a stop condition to the I/O hardware initialization state 422, by an event 403c, which may place the I/O hardware into an I/O hardware stop state 423.

In an alternative aspect, FIG. 4B illustrates various states associated with a heterogeneous computer system architecture where feature activity processing may be distributed between a high-efficiency processor, such as the DSP 105 and a high-performance processor, such as the applications processor 104. Assuming an initial condition whereby feature event processing is being performed in the high performance processor, an example feature system may be started or initialized in an applications processor feature system initialization state 432. The system may prepare for feature detection and may be placed into an applications processor feature system ready state 433 by an event 432a. The I/O hardware may be initialized or started from the applications processor feature system initialization state 432 and placed into an I/O hardware initialization state 435 by an event 432b. The I/O hardware may be started or otherwise brought into a condition to begin processing and may be placed into an I/O hardware capture state 431 by an event 435a. The I/O hardware may be in a condition to begin processing input, and may indicate readiness to the applications processor feature system ready state 433, by an event 435b, that the I/O hardware is in an operational state and ready to begin providing frame data. The I/O hardware capture state 431 may indicate to the applications processor feature system ready state 433, by an event 431a, that a frame or frames are available for processing. The applications processor feature system ready state 433 may loop, by an event 433a, while waiting for a frame and, when an event 431a is received, the applications processor feature system ready state 433 may indicate to an applications processor feature system processing state 434, by an event 433b, to begin processing a frame. The applications processor feature system processing state 434 may generate feature events 434g, which may be processed or may be passed for processing to higher layers, such as user interaction layers as previously described. When the feature events 434g have been generated, the applications processor feature system processing state 434 may indicate to the applications processor feature system ready state 433, by an event 434a, that processing is finished and may receive an indication from the applications processor feature system ready state 433, by an event 433b, to process another frame.

The applications processor feature system processing state 434 may further receive input from a resource monitor state 441 associated with the state of the processing capacities, including available processing capacity of the DSP 105, by an event 441a, which may indicate that an amount of processing may be distributed to the DSP 105. The applications processor feature system processing state 434 may indicate to an applications processor feature system stopping state 438 to wait for feature events, such as feature events that may be forwarded by the DSP 105 when an amount of feature processing is distributed to the DSP 105 as described herein

The resource monitor state 441 may further report a resource state change or the unavailability processing capacity of the DSP 105 by an event 441b. The feature system processing state 434 in preparation to distribute an amount of the feature processing to the DSP 105 may indicate to a DSP feature system stop state 453 two start the DSP feature system by an event 434b. The DSP feature system stop state 453 may indicate to a DSP feature system ready state 452 to prepare for feature detection by an event 453a. The applications processor feature system processing state 434 may continue to control the I/O hardware and may make a frame available for processing to the DSP feature system ready state 452 by an event 434c. The DSP feature system ready state 452 may indicate to a DSP feature system processing state 451 to process the frame by an event 452a. The DSP feature system processing state 451 may generate and indicate feature results to the applications processor feature system stopping state 438 by an event 451a. The applications processor feature system stopping state 438 before the feature results to applications processor feature system processing state 434 by an event 438a. In the above described manner, the applications processor feature system processing state 434 may maintain control over processing and generating feature events while offloading or distributing a significant amount of processing to the DSP 105 depending on the availability of processing capacity or other factors. When the DSP feature system processing state 451 is finished processing, an indication may be made to the DSP feature system ready state 452 by an event 451b.

Processing may continue until such time as estimates of processing capacity requirements for the feature activity indicates that the processing distribution requires changing. The applications processor feature system processing state 434 may indicate to the DSP feature system stop state 453 that the DSP is being relieved, by an event 434b, and processing may be resumed, for example in the applications processor feature system ready state 433 and the applications processor feature system processing state 434. When the feature system processing is completed, such as when a feature system application is being closed, or other conditions associated with the cessation of processing, the applications processor feature system processing state 434 may indicate to the I/O hardware initialization state 435, by an event 434e, that processing may be stopped. The I/O hardware initialization state 435 may indicate to an I/O hardware stop state 436 that the I/O hardware may be stopped by an event 435c. The applications processor feature system processing state 434 may indicate to a feature system stop state 437 that the feature system may be stopped by an event 434f. While example state transitions and events associated with various aspects of feature system processing have been described hereinabove, certain details have been omitted for ease of description or may be described elsewhere herein.

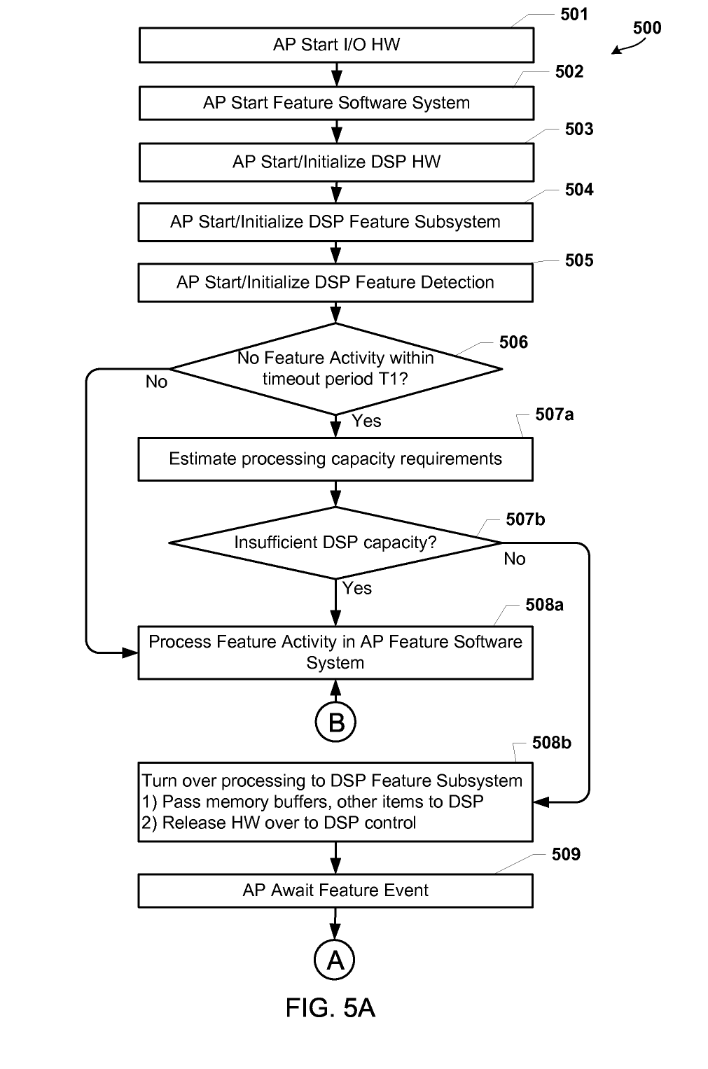

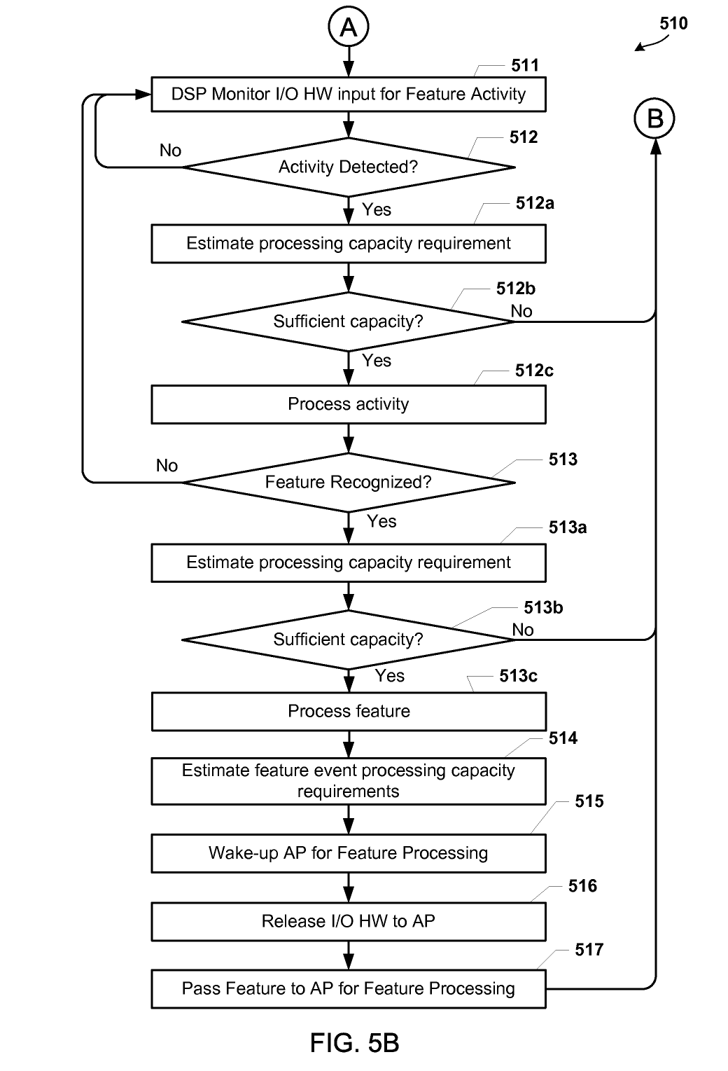

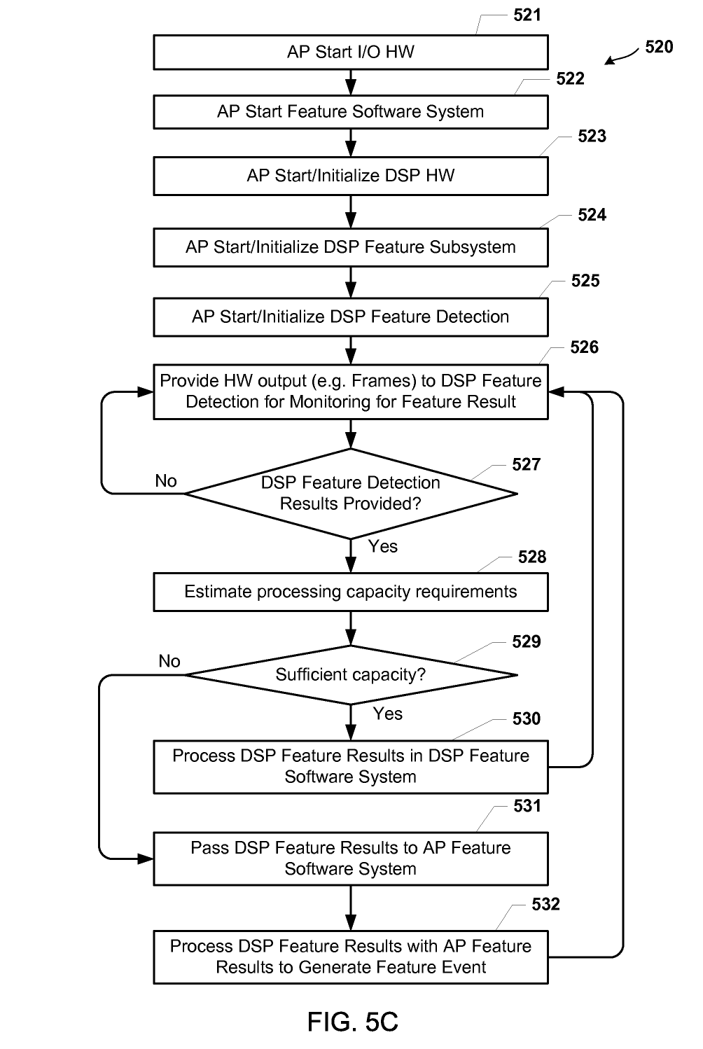

In an aspect method 500 illustrated in FIG. 5A, such as a method of distributing processing capacity, processing capacity requirements may be estimated and a high performance processor, such as the applications processor 104, may enter a low power mode when the required level of processing is within the capabilities of a high-efficiency processor, such as the DSP 105. In that event, feature processing may be transferred to the high-efficiency processor (e.g., a DSP 105). The applications processor 104 may start I/O hardware in block 501. For an example gesture recognition system, starting the I/O hardware may include starting a camera and associated camera control module or driver. The applications processor feature software system may be started in block 502. The applications processor 104 may further start or initialize the DSP 105 depending on the system state in block 503. The applications processor 104 may further start or initialize the DSP feature subsystem in block 504. The applications processor 104 may further start or initialize the DSP feature detection module in block 505. When the applications processor and DSP feature system software modules and I/O hardware have been started or initialize, feature activity may be monitored, such as with the processing capacity of the applications processor 104.

When little or no feature activity is detected within the timeout period T1 (e.g., determination block 506=“YES”), an estimate of the processing capacity requirements, such as may be associated with the available processing capacity of the DSP 105, may be made in block 507a. When DSP processing capacity is insufficient to meet the estimated processing capacity requirements (e.g., determination block 507b=“YES”), high-performance processing capacity may be used to process or continue to process the activity. The applications processor feature software system may process the feature activity in block 508a. Further, if feature activity is detected within the timeout period T1, (e.g. determination block 506=“NO”) the applications processor feature system software may process or continue to process the feature activity in block 508a. When DSP processing capacity is sufficient to meet the estimated processing capacity requirements (e.g., determination block 507b=“NO”), processing may be turned over to (or remain with) the DSP feature subsystem in block 508b. When processing has been turned over to the DSP feature subsystem the applications processor 104 may enter a low power mode and await a feature event in block 509 that may be generated from the DSP feature subsystem and processing may proceed through circle (A) to FIG. 5B.

Continuing with method 500 illustrated In FIG. 5B, from circle (A), the DSP 105 may monitor input received from the I/O hardware, such as frames, for a feature activity in block 511. The monitoring may include processing of the frame data in various algorithms, such as a light/dark detection algorithm, an object detection algorithm, motion detection algorithms, edge detection algorithms, or other image activity related algorithms that generate an outcome indicative of the presence of activity. The input received from the I/O hardware may be image frames, or data that is derived from image frames, such as transform data including histogram data, or other transform data. When activity is detected (e.g., determination block 512=“YES”), an estimate of processing capacity requirements may be generated in block 512a. When no activity is detected (e.g., determination block 512=“NO”) processing may return to block 511 and activity monitoring may continue. When sufficient processing capacity is present to accomplish processing of the activity (e.g., determination block 512b=“YES”), the feature activity may be processed in block 512c. The sufficiency of processing capacity may be determined based, for example, on monitoring the state of instruction queues or buffers, memory usage, or other approaches to determining the available capacity of the processors or processing units. When sufficient processing capacity is not available (e.g., determination block 512b=“NO”), the processing may return to the applications processor feature system software in block 508a of FIG. 5A through path circle (B).

The estimation of processing capacity may include, for example, estimating the processing capacity required to process a predicted feature event associated with the present feature activity. The processing of a predicted future feature event may include estimated future activity, such as the processing of feature recognition, or other expected activity. The estimated processing capacity requirement for the predicted event may be developed from information stored in a memory and available to the processors in the multi-processor system. Such stored information may be based, for example, on previous processing capacity requirements for the predicted activity, or other predictive approaches. In addition, as described elsewhere herein, various levels of processing may be used to elevate the significance of activities as a feature activity becomes more defined. For example, when motion is detected in a scene, low level motion estimation may be used to predict that the detected activity may result in a significant gesture or other feature event.

When a feature is recognized (e.g., determination block 513=“YES”), processing capacity may again be estimated in block 513a. When DSP processing capacity is insufficient to accomplish feature processing, the processing may return through circle (B) to the applications processor feature system software in block 508a of FIG. 5A. Feature recognition may be accomplished, for example, by comparing features associated with a known feature profile, which may be stored in a memory, against features in the present frame or stream of frames. When sufficient processing capacity is present to handle processing of the feature (e.g., determination block 513b=“YES”), the feature may be processed in block 513c. When DSP processing capacity is sufficient to accomplish processing of the feature (e.g., determination block 513b=“NO”), the processing may return to the applications processor feature system software in block 508a of FIG. 5A through path circle (B). When features are not recognized (e.g., determination block 513=“NO”), processing may return to block 511 and activity monitoring may continue.

As feature activity, feature events, and other feature-related phenomena of increasing significance may be detected, the applications processor 104 may eventually be required to fully process the feature events. Thus, an estimate of processing capacity requirements for feature event processing may be made in block 514 to determine whether that feature event processing is required. The applications processor 104 may be awakened for feature event processing in advance of the increased processing capacity requirements in block 515 such that additional processing capacity is available when the events occur or the processing demands pick up. When the applications processor 104 assumes processing for the feature events, the I/O hardware may be released back to the applications processor 104 in block 516. The feature event may further be passed to the applications processor 104 for feature processing in block 517 and processing may return to the applications processor feature system software in block 508a of method 500 shown in FIG. 5A through path circle (B).

In an alternative aspect method 520 illustrated in FIG. 5C, the applications processor 104 and the DSP 105 may be part of a heterogeneous computer architecture whereby the applications processor 104 maintains control over the I/O hardware. Processing may be distributed between the applications processor 104 and the DSP 105 based on processing capacity usage and availability as estimated during feature processing. Thus, the applications processor 104 may start the I/O hardware in block 521. In the computer vision system example, the I/O hardware may include a camera or other image capture device. The applications processor 104 may further start applications processor feature software system processing in block 522. The applications processor 104 may further start or initialize the DSP hardware in block 523, and may start or initialize the DSP feature subsystem in block 524 and the DSP feature detection system in block 525. The I/O hardware output, such as an image frame or frames, may be provided to a DSP feature detection system to monitoring for some level of feature related activity in block 526. The DSP feature detection system may include a variety of modules that may be configured to perform functions, such as outcome generation, feature detection, motion estimation or other basic or specialized functions.

When the DSP feature detection does not provide feature results (e.g., determination block 527=“NO”), processing may return to block 526 and monitoring may be continued. When the DSP feature detection module provides results (e.g., determination block 527=“YES”), processing capacity requirements may be estimated in block 528. When sufficient processing capacity is available for processing results according to the estimated requirements (e.g., determination block 529=“YES”), the DSP feature results may be processed in the DSP feature software system in block 530, and processing may return to block 526 and monitoring may continue. When sufficient processing capacity is not available (e.g., determination block 529=“NO”), the DSP feature results may be passed to the applications processor feature system software in block 531. The DSP feature results may be processed along with applications processor feature results to generate a feature event in block 532. Processing may return to block 526 and monitoring may continue. Alternatively, or in addition to the return of processing to block 526, the system may be stopped under various circumstances, and processing may stop and the system may be placed in an off or idle state, or other condition.

In aspects, depending on the configuration of the software architecture, it may be possible to recognize the presence of activity, basic characteristics of a feature, or other processing associated with predicting the imminence of a feature event, in order to determine whether an estimate should be made of necessary processing capacity. When additional processing capacity is estimated to be required for the predicted event, a request may be made for additional processing capacity for fully processing the feature activity, the feature event, the feature recognition, or other feature related or non-feature related processing task. Additional processing capacity may be requested or otherwise distributed by, for example, queuing or scheduling tasks or processes, which may be likely required for additional processing, for execution. Tasks may be queued or scheduled, or otherwise prepared for execution such that when the predicted feature event or activity occurs, processing may begin immediately. Processing capacity may thereby be conserved and the use of processing capacity may be progressively applied in that a relatively small distribution of processing capacity may be used to make initial determinations of what activity is taking place and what processing capacity might be required. Estimates of required processing capacity and processing distributions needed to conduct additional processing may be made such that necessary processing capacity is made available in advance of when actually required in order to reduce latency of feature handling to the lowest possible level providing distinct advantages over conventional approaches.

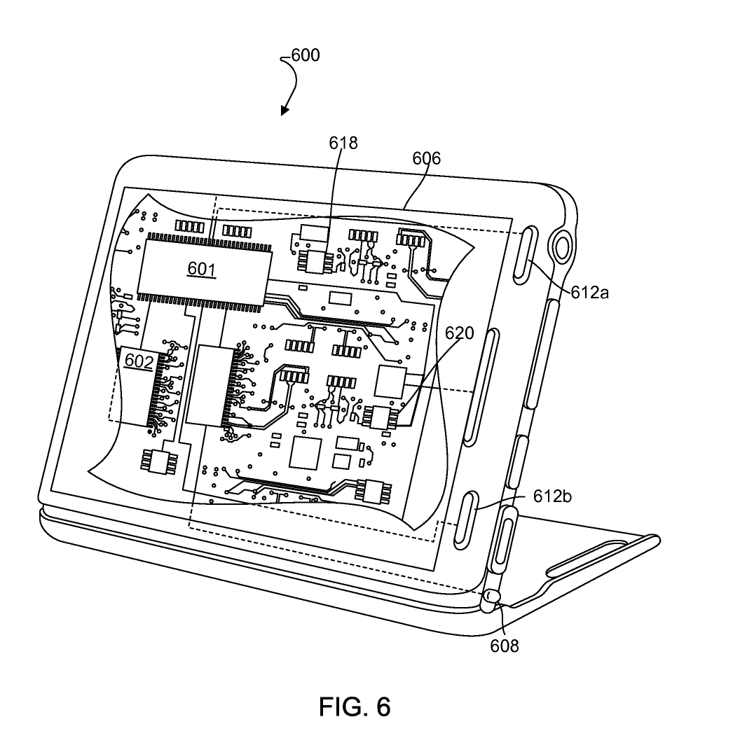

The various aspects described herein may be implemented in any of a variety of mobile computing devices (e.g., smartphones, feature phones, etc.), an example of which is illustrated in FIG. 6. For example, the mobile computing device 600 may include a processor 601 coupled to internal memory 602. The internal memory 602 may be volatile or non-volatile memory, and may also be secure and/or encrypted memory, or unsecure and/or unencrypted memory, or any combination thereof. The processor 601 may also be coupled to a touch screen display 606, such as a resistive-sensing touch screen, capacitive-sensing touch screen infrared sensing touch screen, etc. However, the display of the mobile computing device 600 need not have touch screen capability. The mobile computing device 600 may have one or more short-range radio signal transceivers 618 (e.g., Peanut, Bluetooth®, Zigbee®, RF radio) and antenna 608 for sending and receiving wireless signals as described herein. The transceiver 618 and antenna 608 may be used with the above-mentioned circuitry to implement the various wireless transmission protocol stacks/interfaces. The mobile computing device 600 may include a cellular network wireless modem chip 620 that enables communication via a cellular network. The mobile computing device 600 may also include physical buttons 612a and 612b for receiving user inputs.

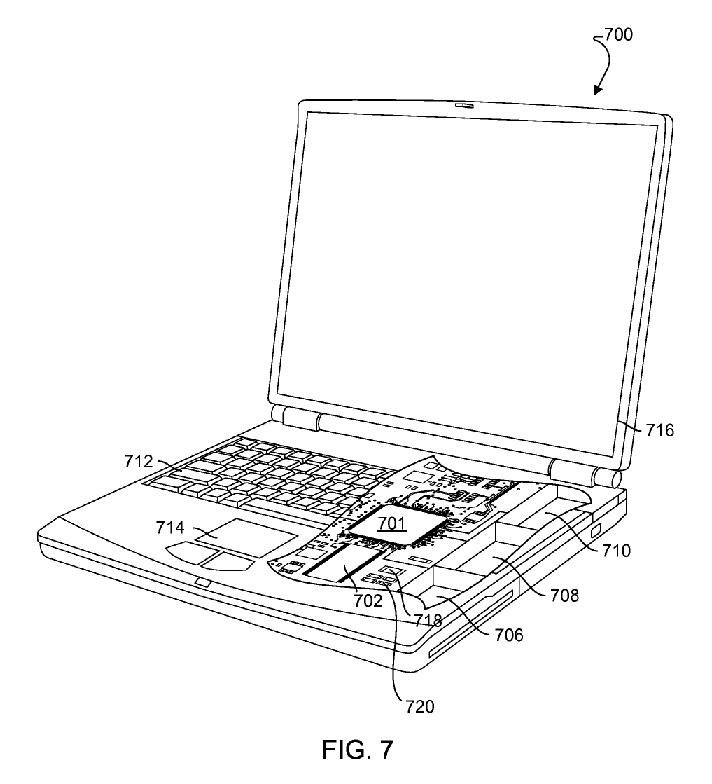

Other forms of computing devices, including personal computers and laptop computers, may be used to implement the various aspects. Such computing devices typically include the components illustrated in FIG. 7 which illustrates an example laptop computer device 700. Many laptop computers include a touch pad touch surface 714 that serves as the computer's pointing device, and thus may receive drag, scroll, and flick gestures similar to those implemented on mobile computing devices equipped with a touch screen display and described above. Such a laptop computer 700 generally includes a processor 701 coupled to volatile internal memory 702 and a large capacity nonvolatile memory, such as a disk drive 706. The laptop computer 700 may also include a compact disc (CD) and/or DVD drive 708 coupled to the processor 701. The laptop computer device 700 may also include a number of connector ports 710 coupled to the processor 701 for establishing data connections or receiving external memory devices, such as a network connection circuit for coupling the processor 701 to a network. The laptop computer device 700 may have one or more short-range radio signal transceivers 718 (e.g., Peanut®, Bluetooth®, Zigbee®, RF radio) and antennas 720 for sending and receiving wireless signals as described herein. The transceivers 718 and antennas 720 may be used with the above-mentioned circuitry to implement the various wireless transmission protocol stacks/interfaces. In a laptop or notebook configuration, the computer housing includes the touch pad 714, the keyboard 712, and the display 716 all coupled to the processor 701. Other configurations of the computing device may include a computer mouse or trackball coupled to the processor (e.g., via a USB input) as are well known, which may also be used in conjunction with the various aspects.

The processors 601 and 701 may be any programmable microprocessor, microcomputer or multiple processor chip or chips that may be configured by software instructions (applications) to perform a variety of functions, including the functions of the various aspects described above. In the various devices, multiple processors may be provided, such as one processor dedicated to wireless communication functions and one processor dedicated to running other applications. Typically, software applications may be stored in the internal memory 602 and 702 before they are accessed and loaded into the processors 601 and 701. The processors 601 and 701 may include internal memory sufficient to store the application software instructions. In many devices the internal memory may be a volatile or nonvolatile memory, such as flash memory, or a mixture of both. For the purposes of this description, a general reference to memory refers to memory accessible by the processors 601 and 701 including internal memory or removable memory plugged into the various devices and memory within the processors 601 and 701.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the,” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more example aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may be stored on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method of distributing processing in a multi-processor system, comprising:
processing a data input to detect a feature activity with a first processor, the first processor comprising a high efficiency processor;
estimating a future processing capacity requirement in response to detecting the feature activity;
determining whether available processing capacity of the first processor is sufficient to meet the estimated future processing capacity requirement; and
signaling that processing the data input on a second processor will be required in response to determining that the available processing capacity of the first processor is insufficient to meet the estimated future processing capacity requirement, the second processor comprising a high performance processor.

2. The method of claim 1, wherein the multi-processor system includes N processing units, the method further comprising:
determining whether available processing capacities of the first processor and the second processor are sufficient to meet the estimated future processing capacity requirement; and
processing the data input on one or more of the N processing units in response to determining that the available processing capacities of the first processor and the second processor are insufficient to meet the estimated future processing capacity requirement.

3. The method of claim 1, wherein signaling that processing the data input on a second processor will be required comprises:
sending a message that processing capacity of the second processor will be required in response to determining that the available processing capacity of the first processor is insufficient to meet the future processing capacity requirement; and
designating the processing capacity of the second processor to process the data input in response to sending the message.

4. The method of claim 1, wherein the data input comprises a data output from a hardware device under control of the first processor, the method further comprising taking control of the hardware device from the first processor by the second processor.

5. The method of claim 4, wherein the hardware device comprises a sensor selected from a group consisting of: an image sensor, an infrared sensor, a light sensor, an ultrasound sensor, and an audio sensor.

6. The method of claim 1, wherein:
the multi-processor system comprises a computer vision system;
the data input comprises an image frame; and
the feature activity comprises visual-feature activity associated with the image frame.

7. The method of claim 1, wherein:
the multi-processor system comprises a computer vision system;
the data input comprises an image histogram associated with an image frame; and
the feature activity comprises visual-feature activity associated with the image histogram.

8. The method of claim 1, further comprising:
estimating a current processing capacity requirement based on the processing of data input by the second processor;
determining whether an available processing capacity of the first processor is sufficient to meet the estimated current processing capacity requirement; and
processing the data input on the first processor and transitioning the second processor to a low power state in response to determining that available processing capacity of the first processor is sufficient to meet the estimated current processing capacity requirement.

9. The method of claim 1, wherein the data input comprises an image frame.

10. The method of claim 9, wherein:
processing the data input to detect the feature activity comprises processing the data input to detect an object in the image frame having a likelihood of being a start of a gesture; and
estimating a future processing capacity requirement comprises estimating the future processing capacity requirement to recognize the gesture within a series of image frames.

11. The method of claim 9, wherein:
processing the data input to detect the feature activity comprises processing the data input to detect a face in the image frame; and
estimating the future processing capacity requirement comprises estimating the future processing capacity requirement to perform facial recognition on a detected face within a series of image frames.

12. The method of claim 1, wherein the data input comprises an image histogram associated with an image frame.

13. The method of claim 1, wherein the data input includes audio data.

14. The method of claim 13, wherein:
processing the data input to detect the feature activity comprises processing the data input to detect a voice signal in the audio data; and
estimating the future processing capacity requirement comprises estimating the future processing capacity requirement to perform voice recognition on the voice signal in the audio data.

15. The method of claim 1, wherein the multi-processor system comprises a system-on-chip (SoC).

16. The method of claim 1, wherein the first processor comprises a digital signal processor (DSP).

17. The method of claim 1, wherein the second processor comprises an applications processor.

18. A multi-processor system, comprising:
a first processor comprising a high efficiency processor;
a second processor comprising a high performance processor; and
a resource manager coupled to the first and second processors, wherein at least the first processor and the resource manager are configured with processor-executable instructions to perform operations comprising:
processing a data input to detect a feature activity;
estimating a future processing capacity requirement in response to detecting the feature activity;
determining whether available processing capacity of the first processor is sufficient to meet the estimated future processing capacity requirement; and
signaling that processing capacity of the second processor will be required for processing the data input, in response to determining that the available processing capacity of the first processor is insufficient to meet the estimated future processing capacity requirement.

19. The multi-processor system of claim 18, wherein the estimated future processing capacity requirement is associated with processing a feature event and wherein the second processor is configured with processor-executable instructions to perform operations comprising processing the feature event within the data input.

20. The multi-processor system of claim 18, wherein:
the second processor comprises a multi-core processor with multiple processing cores; and
the required processing capacity of the second processor comprise at least one of the multiple processing cores.

21. The multi-processor system of claim 18, wherein at least the resource manager is configured with processor-executable instructions to perform operations such that signaling that processing the data input on a second processor will be required comprises:
sending a message that processing capacity of the second processor will be required in response to determining that the available processing capacity of the first processor is insufficient to meet the future processing capacity requirement; and
designating the processing capacity of the second processor to process the data input in response to sending the message.

22. The multi-processor system of claim 18, further comprising N processing units configured with processor executable instructions to perform operations, in connection with at least the resource manager, comprising:
determining whether available processing capacities of the first processor and the second processor are sufficient to meet the estimated future processing capacity requirement; and
processing the data input on at least one of the N processing units in response to determining that the available processing capacities of the first processor and the second processor are insufficient to meet the future processing capacity requirement.

23. The multi-processor system of claim 18, wherein:
the data input comprises a data output from a hardware device under control of the first processor; and
the second processor is configured with processor-executable instructions to perform operations comprising taking control of the hardware device from the first processor.

24. The multi-processor system of claim 23, wherein the hardware device comprises a sensor selected from a group consisting of: an image sensor, an infrared sensor, a light sensor, an ultrasound sensor, and an audio sensor.

25. The multi-processor system of claim 18, wherein:
the multi-processor system comprises a computer vision system;
the data input comprises an image frame; and
the feature activity comprises visual-feature activity associated with the image frame.

26. The multi-processor system of claim 18, wherein:
the multi-processor system comprises a computer vision system;
the data input comprises an image histogram associated with an image frame; and
the feature activity comprises visual-feature activity associated with the image histogram.

27. The multi-processor system of claim 18, wherein the second processor is configured with processor-executable instructions to perform operations further comprising:
estimating a current processing capacity requirement based on the processing of the data input by the second processor:
determining whether an available processing capacity of the first processor is sufficient to meet the estimated current processing capacity requirement; and
processing the data input on the first processor and transitioning the second processor to a low power state in response to determining that available processing capacity of the first processor is sufficient to meet the estimated current processing capacity requirement.

28. The multi-processor system of claim 18, wherein the data input comprises an image frame.

29. The multi-processor system of claim 18, wherein the data input comprises an image histogram associated with an image frame.

30. The multi-processor system of claim 28, wherein at least the first processor and the resource manager are configured with processor executable instructions to perform operations such that processing the data input to detect a feature activity and estimating a future processing capacity requirement comprises:
processing the data input to detect an object in the image frame having a likelihood of being a start of a gesture; and
estimating the future processing capacity requirement to recognize the gesture within a series of image frames.

31. The multi-processor system of claim 28, wherein at least the first processor and the resource manager are configured with processor executable instructions to perform operations such that processing a data input to detect a feature activity and estimating a future processing capacity requirement comprises:
processing the data input to detect a face in the image frame; and
estimating the future processing capacity requirement to perform facial recognition on a detected face within a series of image frames.

32. The multi-processor system of claim 18, wherein the data input includes audio data.

33. The multi-processor system of claim 32, wherein at least the first processor and the resource manager are configured with processor executable instructions to perform operations such that processing the data input to detect a feature activity and estimating a future processing capacity requirement comprises:
processing the data input to detect a voice signal in the audio data; and
estimating the future processing capacity requirement to perform voice recognition on the voice signal in the audio data.

34. The multi-processor system of claim 18, comprising a system-on-chip (SoC).

35. The multi-processor system of claim 18, wherein the first processor comprises a digital signal processor (DSP).

36. The multi-processor system of claim 18, wherein the second processor comprises an applications processor.

37. A multi-processor system, comprising:
a high efficiency processor configured to detect a feature activity in a data input;
a high performance processor;
means for estimating a future processing capacity requirement in response to detecting the feature activity;
means for determining whether available processing capacity of the high performance processor is sufficient to meet the estimated future processing capacity requirement; and
means for signaling that a processing capacity of the high performance processor will be required for processing the data input, in response to determining that the available processing capacity of the high efficiency processor is insufficient to meet the estimated future processing capacity requirement.

38. The multi-processor system of claim 37, wherein:
the estimated future processing capacity requirement is associated with processing a feature event; and
the high performance processor processes the feature event within the data input.

39. The multi-processor system of claim 37, wherein:
The high performance processor comprises a multi-core processor with multiple processing cores; and
the required processing capacity comprises at least one of the multiple processing cores.

40. The multi-processor system of claim 37, wherein means for signaling that processing the data input on the high performance processor will be required for processing the data input sends a message that the processing capacity of the high performance processor will be required in response to determining that the available processing capacity of the high efficiency processor is insufficient to meet the future processing capacity requirement; and designates the processing capacity of the high performance processor to process the data input in response to sending the message.

41. The multi-processor system of claim 37, wherein:
the means for determining whether available processing capacity of the high efficiency processor further determines whether available processing capacities of the high efficiency processor and the high performance processor are sufficient to meet the estimated future processing capacity requirement; and
the multi-processor system further comprises N means for processing the data input in response to determining that the available processing capacities of the high efficiency processor and the high performance processor are insufficient to meet the future processing capacity requirement.

42. The multi-processor system of claim 37, wherein:
the data input comprises a data output from a hardware device under control of the high efficiency processor; and
the high performance processor takes control of the hardware device from the high efficiency processor.

43. The multi-processor system of claim 42, wherein the hardware device comprises a sensor selected from a group consisting of: an image sensor, an infrared sensor, a light sensor, an ultrasound sensor, and an audio sensor.

44. The multi-processor system of claim 37, wherein:
the multi-processor system comprises a computer vision system;
the data input comprises an image frame; and
the feature activity comprises visual-feature activity associated with the image frame.

45. The multi-processor system of claim 37, wherein:
the multi-processor system comprises a computer vision system;
the data input comprises an image histogram associated with an image frame; and
the feature activity comprises visual-feature activity associated with the image histogram.

46. The multi-processor system of claim 37, wherein the high performance processor estimates a current processing capacity requirement based on the processing of the data input, determines whether an available processing capacity of the high efficiency processor is sufficient to meet the estimated current processing capacity requirement, and transfers the processing the data input to the high efficiency processor, and transitions to a low power state in response to determining that available processing capacity of the high efficiency processor is sufficient to meet the estimated current processing capacity requirement.

47. The multi-processor system of claim 37, wherein the data input comprises an image frame.

48. The multi-processor system of claim 37, wherein the data input comprises an image histogram associated with an image frame.

49. The multi-processor system of claim 47, wherein:
the high efficiency processor processes the data input to detect an object in the image frame having a likelihood of being a start of a gesture; and
the means for estimating a future processing capacity requirement comprises means for estimating the future processing capacity requirement to recognize the gesture within a series of image frames.

50. The multi-processor system of claim 47, wherein:
the high efficiency processor processes the data input to detect a face in the image frame; and
means for estimating a future processing capacity requirement comprises means for estimating the future processing capacity requirement to perform facial recognition on a detected face within a series of image frames.

51. The multi-processor system of claim 37, wherein the data input includes audio data.

52. The multi-processor system of claim 51, wherein
the high efficiency processor processes the data input to detect a voice signal in the audio data; and
means for estimating a future processing capacity requirement comprises means for estimating the future processing capacity requirement to perform voice recognition on the voice signal in the audio data.

53. The multi-processor system of claim 37, comprising a system-on-chip (SoC).

54. The multi-processor system of claim 37, wherein the high efficiency processor comprises a digital signal processor (DSP).

55. The multi-processor system of claim 37, wherein the high performance processor comprises an applications processor.

56. A non-transitory computer-readable storage medium having stored thereon processor-executable software instructions configured to cause one or more processors in a multi-processor system for distributing processing to perform operations comprising:
processing a data input to detect a feature activity with a first processor, the first processor comprising a high efficiency processor;
estimating a future processing capacity requirement in response to detecting the feature activity;
determining whether available processing capacity of the first processor is sufficient to meet the estimated future processing capacity requirement; and
signaling that processing the data input on a second processor will be required in response to determining that the available processing capacity of the first processor is insufficient to meet the estimated future processing capacity requirement, the second processor comprising a high performance processor.

57. The non-transitory computer-readable storage medium of claim 56, wherein:
the multi-processor system includes N processing units; and
the stored processor-executable software instructions are configured to cause the one or more processors in the multi-processor system to perform operations further comprising:
determining whether available processing capacities of the first processor and the second processor are sufficient to meet the estimated future processing capacity requirement; and
processing the data input on one or more of the N processing units in response to determining that the available processing capacities of the first processor and the second processor are insufficient to meet the estimated future processing capacity requirement.

58. The non-transitory computer-readable storage medium of claim 56, wherein the stored processor-executable software instructions are configured to cause the one or more processors in the multi-processor system to perform operations such that signaling that processing the data input on a second processor will be required comprises:
sending a message that processing capacity of the second processor will be required in response to determining that the available processing capacity of the first processor is insufficient to meet the future processing capacity requirement; and
designating the processing capacity of the second processor to process the data input in response to sending the message.

59. The non-transitory computer-readable storage medium of claim 56, wherein:
the data input comprises a data output from a hardware device under control of the first processor; and
the stored processor-executable software instructions are configured to cause the one or more processors in the multi-processor system to perform operations further comprising taking control of the hardware device from the first processor by the second processor.

60. The non-transitory computer-readable storage medium of claim 59, wherein the hardware device comprises a sensor selected from a group consisting of an image sensor, an infrared sensor, a light sensor, an ultrasound sensor, and an audio sensor.

61. The non-transitory computer-readable storage medium of claim 56, wherein:
the multi-processor system comprises a computer vision system;
the data input comprises an image frame; and
the feature activity comprises visual-feature activity associated with the image frame.

62. The non-transitory computer-readable storage medium of claim 56, wherein:
the multi-processor system comprises a computer vision system;
the data input comprises an image histogram associated with an image frame; and
the feature activity comprises visual-feature activity associated with the image histogram.

63. The non-transitory computer-readable storage medium of claim 56, wherein the stored processor-executable software instructions are configured to cause the one or more processors in the multi-processor system to perform operations further comprising:
estimating a current processing capacity requirement based on the processing of data input by the second processor;
determining whether an available processing capacity of the first processor is sufficient to meet the estimated current processing capacity requirement; and
processing the data input on the first processor and transitioning the second processor to a low power state in response to determining that available processing capacity of the first processor is sufficient to meet the estimated current processing capacity requirement.

64. The non-transitory computer-readable storage medium of claim 56, wherein the data input comprises an image frame.

65. The non-transitory computer-readable storage medium of claim 64, wherein the stored processor-executable software instructions are configured to cause the one or more processors in the multi-processor system to perform operations such that processing the data input to detect the feature activity and estimating a future processing capacity requirement comprises:
processing the data input to detect an object in the image frame having a likelihood of being a start of a gesture; and
estimating a future processing capacity requirement to recognize the gesture within a series of image frames.

66. The non-transitory computer-readable storage medium of claim 64, wherein the stored processor-executable software instructions are configured to cause the one or more processors in the multi-processor system to perform operations such that processing a data input to detect a feature activity and estimating the future processing capacity requirement comprises:
processing the data input to detect a face in the image frame; and
estimating the future processing capacity requirement to perform facial recognition on a detected face within a series of image frames.

67. The non-transitory computer-readable storage medium of claim 56, wherein the data input comprises an image histogram associated with an image frame.

68. The non-transitory computer-readable storage medium of claim 56, wherein the data input includes audio data.

69. The non-transitory computer-readable storage medium of claim 68, wherein the stored processor-executable software instructions are configured to cause the one or more processors in the multi-processor system to perform operations such that processing the data input to detect the feature activity and estimating the future processing capacity requirement comprises:
processing the data input to detect a voice signal in the audio data; and
estimating the future processing capacity requirement to perform voice recognition on the voice signal in the audio data.

70. The non-transitory computer-readable storage medium of claim 56, wherein the multi-processor system comprises a system-on-chip (SoC).

71. The non-transitory computer-readable storage medium of claim 56, wherein the first processor comprises a digital signal processor (DSP).

72. The non-transitory computer-readable storage medium of claim 56, wherein the second processor comprises an applications processor.
